(19) United States
(12) Patent Application Publication
(10) Pub. No.: US 2026/0135298 A1
(43) Pub. Date: May 14, 2026

(54) TERMINAL ANTENNA AND WEARABLE DEVICE

(71) Applicant: Honor Device Co., Ltd., Shenzhen (CN)

(72) Inventors: Jian Luo, Shenzhen (CN); Kaiming Dong, Shenzhen (CN); Zhenhua Cao, Shenzhen (CN)

(21) Appl. No.: 18/705,763

(22) PCT Filed: Apr. 26, 2023
(86) PCT No.: PCT/CN2023/091002

§ 371 Date: Apr. 29, 2024

(30) Foreign Application Priority Data
May 27, 2022 (CN) 202210588571.6

(51) Int. Cl. H01Q 5/378; H01Q 5/20

(52) U.S. Cl. CPC H01Q 5/378; H01Q 5/20

(57) ABSTRACT

Embodiments of this application disclose a terminal antenna and a wearable device, and relates to the field of antenna technologies. The terminal antenna includes a first radiator, a reference ground, and a metal ring structure. The first radiator has a hollow structure. A projection of the reference ground on a plane on which the first radiator is located is located inside the hollow structure of the first radiator. A projection of the metal ring structure on the first radiator is not beyond the structure of the first radiator. When the wearable device is in a worn state, a distance between the metal ring structure and a user is less than that between the first radiator and the user.

### CROSS-REFERENCE TO RELATED APPLICATIONS

This application is a national stage of International Application No. PCT/CN2023/091002, filed on Apr. 26, 2023, which claims priority to Chinese Patent Application No. 202210588571.6, filed on May 27, 2022. The disclosures of both of the aforementioned applications are hereby incorporated by reference in their entireties.

### TECHNICAL FIELD

This application relates to the field of antenna technologies, and in particular, to a terminal antenna and a wearable device.

### BACKGROUND

With the development of a smart wearable device, the smart wearable device has increasing functions. The smart wearable device may implement a wireless communication function through an antenna arranged in the smart wearable device.

When the smart wearable device is in a worn state, the antenna in the smart wearable device is close to a human body (for example, a forearm), the forearm significantly affects radiation performance of the antenna in the device.

### SUMMARY

Embodiments of this application provide a terminal antenna and a wearable device. A parasitic ring structure is arranged to perform weakening adjustment on a magnetic field on a side close to a human body, to reduce absorption of radiation of the antenna by the human body and improve radiation performance of the antenna.

To achieve the foregoing objective, the following technical solutions are used in embodiments of this application.

A first aspect provides a terminal antenna. The terminal antenna includes a first radiator, a reference ground, and a metal ring structure. The first radiator has a hollow structure. A projection of the reference ground on a plane on which the first radiator is located is located inside the hollow structure of the first radiator. A projection of the metal ring structure on the first radiator is not beyond the structure of the first radiator. When a wearable device is in a worn state, a distance between the metal ring structure and a user is less than that between the first radiator and the user.

Based on this solution, the metal ring structure is arranged on a side, close to a human body, of the antenna, to implement weakening adjustment on a magnetic field on the side close to the human body in a radiation process of the antenna. In this way, a loss of a radiated electromagnetic wave caused by absorption by the human body is reduced. Therefore, a loss of overall radiation performance of the antenna caused by the human body is reduced, and radiation performance of the antenna is improved. The distance between the metal ring structure and the user may be a minimum distance between the metal ring structure and skin of a forearm on which the wearable device is worn. Similarly, the distance between the first radiator and the user may be a minimum distance between the first radiator and the skin of the forearm on which the wearable device is worn.

In a possible design, the metal ring structure is a parasitic ring structure. Based on this solution, a specific limitation on the metal ring structure is provided. For example, the metal ring structure may be a parasitic ring structure that is disconnected from the first radiator and the reference ground and that can perform radiation through energy coupling.

In the following design, an example in which the metal ring structure is the parasitic ring structure is used.

In a possible design, a perimeter of the first radiator corresponds to an N/2 wavelength of an operating frequency band of the terminal antenna. The parasitic ring structure is provided with at most N openings, and any one of the at most N openings is provided close to a weak current point generated when the first radiator operates. Alternatively, the parasitic ring structure is a closed ring structure. Based on this solution, a specific structural feature of the parasitic ring structure is provided. When the first radiator corresponds to a metal bezel, the bezel may have different sizes in different application scenarios. Therefore, an operation mode corresponding to the first radiator may be flexibly selected based on an operating frequency band required to be covered and a size of the bezel, to correspondingly adjust the quantity and positions of openings of the parasitic ring structure.

In a possible design, the parasitic ring structure is arranged close to the first radiator. When the terminal antenna operates, a current direction on the parasitic ring structure is opposite to that on the first radiator. Based on this solution, an operation example in which the parasitic ring structure is arranged close to the bezel is provided. A current in a direction opposite to that on the bezel is excited on a parasitic ring to form a magnetic field correspondingly opposite to the bezel, to implement weakening adjustment on a magnetic field radiated by the bezel.

In a possible design, that the parasitic ring structure is arranged close to the first radiator includes: the parasitic ring structure is arranged in a first region, where the first region includes a projection region of a gap between the first radiator and the reference ground on a plane on which the parasitic ring structure is located, and/or a projection region of the first radiator on a plane on which the parasitic ring structure is located. Alternatively, when the parasitic ring structure is provided with an opening, a middle part of at least one continuous radiator in the parasitic ring structure is arranged in a first region. Based on this solution, a specific implementation solution used when the parasitic ring is arranged close to the bezel is provided. For example, the parasitic ring may be arranged in the gap away from the reference ground and close to the bezel or arranged in a radiator perpendicular projection region of the bezel. In some implementations, weakening adjustment needs to be performed on the magnetic field. Therefore, a position of the parasitic ring close to a large current point of the bezel may be arranged in the first region, and a position of another part (for example, close to the opening) may be flexibly adjusted. Similarly, when the parasitic ring is a closed ring structure, the position close to the large current point of the bezel is arranged in the first region, and the position of the another part may be flexibly adjusted.

In a possible design, when the terminal antenna operates, a first parasitic resonance corresponding to a half-wavelength mode is excited on the parasitic ring structure, and a main resonance corresponding to an N/2-wavelength mode is excited on the first radiator. A frequency band covered by the first parasitic resonance at least partly coincides with that covered by the main resonance. A central frequency of the first parasitic resonance is lower than that of the main resonance. When the parasitic ring is arranged close to the bezel, the corresponding parasitic resonance may be designed to be lower than the main resonance. Therefore, radiation performance of the main resonance is improved.

In a possible design, the parasitic ring structure is arranged close to the reference ground. When the terminal antenna operates, a current direction on the parasitic ring structure is opposite to that on the reference ground. Based on this solution, an operation example in which the parasitic ring structure is arranged close to a floor is provided. A current in a direction opposite to that on the floor is excited on a parasitic ring to form a magnetic field correspondingly opposite to the floor, to implement weakening adjustment on a magnetic field radiated by the floor.

In a possible design, that the parasitic ring structure is arranged close to the reference ground includes: the parasitic ring structure is arranged in a second region, where the second region includes a projection region of the reference ground on a plane on which the parasitic ring structure is located. Alternatively, when the parasitic ring structure is provided with an opening, a middle part of at least one continuous radiator in the parasitic ring structure is arranged in a second region. Based on this solution, a specific implementation solution used when the parasitic ring is arranged close to the floor is provided. For example, the parasitic ring may be arranged in a gap away from the reference ground and close to the floor or arranged in a radiator perpendicular projection region of the floor. In some implementations, weakening adjustment needs to be performed on the magnetic field. Therefore, a position of the parasitic ring close to a large current point of the floor (that is, away from a large current point of the bezel) may be arranged in the first region, and a position of another part (for example, close to the opening) may be flexibly adjusted. Similarly, when the parasitic ring is a closed ring structure, the position close to the large current point of the floor is arranged in the first region, and the position of the another part may be flexibly adjusted.

In a possible design, when the terminal antenna operates, a second parasitic resonance corresponding to a half-wavelength mode is excited on the parasitic ring structure, and a main resonance corresponding to an N/2-wavelength mode is excited on the first radiator. A frequency band covered by the second parasitic resonance at least partly coincides with that covered by the main resonance. When the parasitic ring is arranged close to the bezel, the corresponding parasitic resonance may be designed to be lower than the main resonance, or may be set to be lower than the main resonance. Therefore, radiation performance of the main resonance is improved.

In a possible design, the parasitic ring structure is provided with at least one opening. If cross sections of some radiators on a parasitic ring opposite to the opening are smaller than those of other radiators, a frequency band covered by a resonance excited on the parasitic ring structure is lower; or if cross sections of some radiators on a parasitic ring opposite to the opening are larger than those of other radiators, a frequency band covered by a resonance excited on the parasitic ring structure is higher. Therefore, equivalent inductance of a radiator close to a large current point can be adjusted to adjust a frequency corresponding to a parasitic resonance.

In a possible design, the parasitic ring structure is a closed ring structure. If cross sections of some regions of the metal ring structure are smaller than those of other regions, a frequency band covered by a resonance excited on the metal ring structure is lower. Therefore, when the parasitic ring structure is a closed ring structure, a cross sectional size at a corresponding position may be adjusted to adjust a frequency range of a parasitic resonance.

In a possible design, the parasitic ring structure is provided with the at least one opening. The parasitic ring structure includes a first part and a second part at a position of the opening. The first part at least partly coincides with the second part to form equivalent capacitance. If the equivalent capacitance is higher, the frequency band covered by the resonance excited on the parasitic ring structure is lower; or if the equivalent capacitance is lower, the frequency band covered by the resonance excited on the parasitic ring structure is higher. Therefore, equivalent capacitance of a radiator close to a small current point can be adjusted to adjust a frequency corresponding to a parasitic resonance.

It should be understood that similar to the solution, in the foregoing design, in which inductive sensing is adjusted in the closed parasitic ring structure by adjusting a cross sectional size, to adjust a frequency corresponding to a parasitic resonance, in some other designs of this application, when the parasitic ring structure is a closed ring structure, a cross sectional size at a corresponding position may also be adjusted with reference to the position in the foregoing opening design, to achieve the effect of adjusting an equivalent capacitance component at the position. In this way, a capacitive loading magnitude is adjusted through structural adjustment, to adjust the frequency corresponding to the parasitic resonance.

In a possible design, projection regions of the first part and the second part on the first radiator coincide. In this way, a structural feature of a distributed capacitance structure of the first part and the second part at the opening is clear.

A second aspect provides a wearable device. The terminal antenna according to the first aspect and any possible design of the first aspect is arranged in the wearable device.

In a possible design, the wearable device is a smartwatch, and the first radiator is a metal bezel of the smartwatch.

In a possible design, the parasitic ring structure is arranged on a watch bottom. For example, the parasitic ring structure may be arranged on a side, close to a human body, of the watch bottom. Alternatively, the parasitic ring structure may be arranged inside the watch bottom.

It should be understood that the technical features of the technical solution provided in the second aspect above can all correspond to the terminal antenna provided in the first aspect and any possible design of the first aspect, and therefore, similar beneficial effects can be achieved. Details are not described herein again.

### BRIEF DESCRIPTION OF THE DRAWINGS

FIG. 1 is a schematic diagram of a worn state of a smartwatch;

FIG. 2 is a schematic diagram of arrangement of a bezel of a smartwatch and a floor;

FIG. 3 is a schematic diagram of an antenna solution of a smartwatch;

FIG. 4 is a schematic diagram of comparison between two antenna solutions of a smartwatch;

FIG. 5 is a schematic diagram of a scenario in which a smartwatch is worn;

FIG. 6 is a schematic diagram of comparison between an antenna solution according to an embodiment of this application during operation and the conventional technology;

FIG. 7 is a schematic diagram of composition of a wearable device according to an embodiment of this application;

FIG. 8 is a schematic diagram of an antenna solution according to an embodiment of this application;

FIG. 9 is a schematic diagram of implementation of an antenna solution;

FIG. 10 is a schematic diagram of a parasitic ring arrangement solution according to an embodiment of this application;

FIG. 11 is a schematic diagram of an electrical parameter distribution during operation of an antenna solution according to an embodiment of this application;

FIG. 12 is a schematic diagram of a parasitic ring arrangement solution according to an embodiment of this application;

FIG. 13 is a schematic diagram of an electrical parameter distribution during operation of an antenna solution according to an embodiment of this application;

FIG. 14 is a schematic diagram of composition of an antenna structure according to an embodiment of this application;

FIG. 15 is a schematic diagram of dimensioning of an antenna structure according to an embodiment of this application;

FIG. 16 is a schematic diagram of an electrical parameter distribution during operation of an antenna solution according to an embodiment of this application;

FIG. 17 is a schematic diagram of simulation according to an embodiment of this application;

FIG. 18 is a schematic diagram of simulation when a parasitic resonance is higher or lower than a main resonance according to an embodiment of this application;

FIG. 19 is a schematic diagram of composition of an antenna structure according to an embodiment of this application;

FIG. 20 is a schematic diagram of dimensioning of an antenna structure according to an embodiment of this application;

FIG. 21 is a schematic diagram of an electrical parameter distribution during operation of an antenna solution according to an embodiment of this application;

FIG. 22 is a schematic diagram of simulation according to an embodiment of this application;

FIG. 23 is a schematic diagram of simulation when a parasitic resonance is higher or lower than a main resonance according to an embodiment of this application;

FIG. 24 is a schematic diagram of simulation when a parasitic ring is close to an arm of a human body according to an embodiment of this application;

FIG. 25 is a schematic diagram of composition of an antenna structure according to an embodiment of this application;

FIG. 26 is a schematic diagram of composition of an antenna structure according to an embodiment of this application;

FIG. 27 is a schematic diagram of composition of an antenna structure according to an embodiment of this application;

FIG. 28 is a schematic diagram of composition of an antenna structure in a ½-wavelength mode according to an embodiment of this application;

FIG. 29 is a schematic diagram of solution implementation of inductive loading and capacitive loading according to an embodiment of this application;

FIG. 30 is a schematic diagram of composition of an antenna structure in a 3/2-wavelength mode according to an embodiment of this application;

FIG. 31 is a schematic diagram of solution implementation of inductive loading and capacitive loading according to an embodiment of this application;

FIG. 32 is a schematic diagram of composition of an antenna structure in a 4/2-wavelength mode according to an embodiment of this application;

FIG. 33 is a schematic diagram of solution implementation of inductive loading and capacitive loading according to an embodiment of this application;

FIG. 34 is a schematic diagram of a solution of a closed parasitic ring structure according to an embodiment of this application;

FIG. 35 is a schematic diagram of simulation when a closed parasitic ring structure is arranged close to a bezel according to an embodiment of this application; and

FIG. 36 is a schematic diagram of simulation when a closed parasitic ring structure is arranged close to a floor according to an embodiment of this application.

### DETAILED DESCRIPTION OF ILLUSTRATIVE EMBODIMENTS

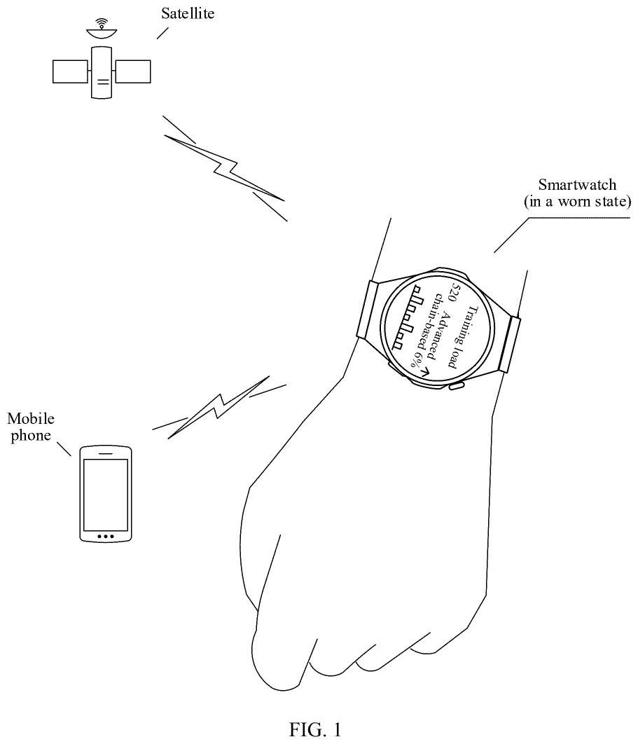

At present, a smart wearable device has been widely used. For example, the smart wearable device is a smartwatch. The smartwatch may be worn on a forearm (for example, a wrist) of a user to provide the user with smart experience. For example, refer to FIG. 1. In some scenarios, the smartwatch may provide the user with a positioning function. For example, the smartwatch may communicate wirelessly with a positioning device such as a satellite to obtain current positioning information. In some other scenarios, the smartwatch may also monitor physical information of the user, for example, a heart rate and other physical information of the user during exercise. The smartwatch may communicate wirelessly with another electronic device (for example, a mobile phone) and send the obtained physical information to the mobile phone to implement data sharing. In some other scenarios, the smartwatch may also provide voice calls and data connection functions. For example, the voice calls may be voice calls based on networks such as GSM, VoLTE, TDSCDMA, CDMA, and VONR, and the data connection functions may be data connections based on networks such as WCDMA, TDSCDMA, CDMA, LTE, 5G NR, Bluetooth, and WiFi (for example, 2.4G WiFi and 5G WiFi). In some other scenarios, the smartwatch may also have the positioning function. For example, a UWB antenna may be arranged in the smartwatch to implement positioning of other electronic devices and the like.

An antenna may be arranged in the smart wearable device, to implement a wireless communication function in the above example. Due to a limited size of the smart wearable device, a space that can be provided for the antenna is correspondingly small. Then, in some designs, a metal structure in the smart wearable device may be reused, to miniaturize the antenna.

For example, the smartwatch is still used as an example. The smartwatch may include a plurality of components capable of providing a rigid support, for example, a bezel made of a metal material, and a watch bottom made of a non-metal material such as plastics or ceramics. The bezel may provide a support for the smartwatch in all directions. In some implementations, when the bezel is made of the metal material, the bezel may also be used as an antenna radiator to implement structural reuse. The watch bottom may provide a bottom support for the smartwatch. At least one printed circuit board (Printed Circuit Board, PCB) and/or flexible printed circuit (Flexible Printed Circuit Board, FPC) may also be arranged on the watch bottom. In this application, the at least one PCB and/or FPC may be configured to carry components inside the smartwatch, for example, electronic components such as a communication chip, a radio frequency device, a power amplifier, and a filter device. To enable the electronic components to normally operate, a reference ground may also be arranged on the at least one PCB and/or FPC. The reference ground may provide a zero-potential reference for the electronic components. In some implementations, the reference ground may implement a reference ground function by laying metal materials (such as copper) in the at least one PCB and/or FPC. For ease of description, in the following description, the reference ground formed by the at least one PCB and/or FPC is collectively referred to as a floor for illustration.

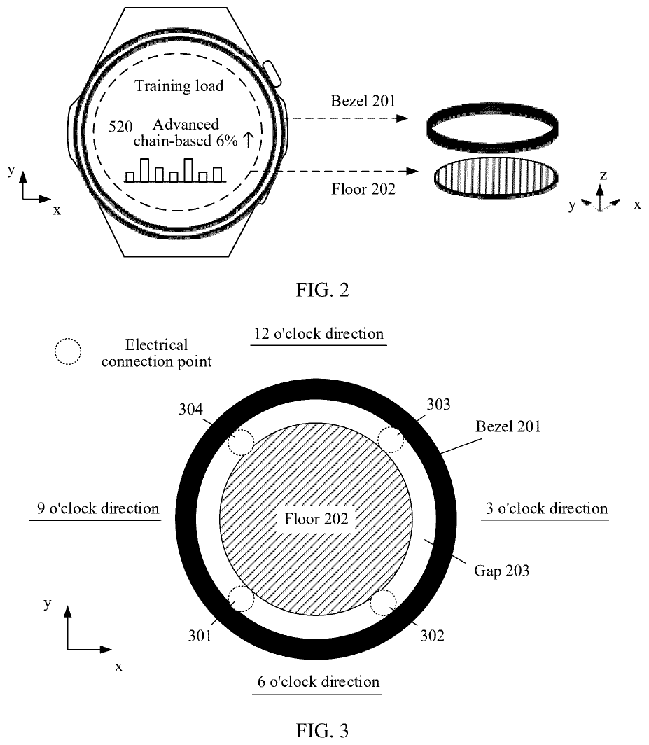

Refer to FIG. 2. A bezel 201 and a floor 202 may be arranged in the smartwatch. Both the bezel 201 and the floor 202 may be metal structures. Then, the antenna may be arranged in the smartwatch with metal conductive characteristics of the bezel 201 and the floor 202.

The bezel 201 may be used as an antenna radiator for radiation. The floor 202 may be used as a reference ground of the antenna. In this way, when the antenna operates, currents on the bezel 201 and the floor 202 are excited to implement radiation of the antenna.

In an example, FIG. 3 shows an antenna arrangement solution of the smartwatch. In this solution, a plurality of electrical connection points may be arranged in a gap 203 between the bezel 201 and the floor 202. The plurality of electrical connection points may be configured to arrange a feed point and a ground point. For the solution example in FIG. 3, reference may be made to the invention application No. CN 112909503 A.

As shown in FIG. 3, in the solution in this example, the plurality of electrical connection point may include electrical connection points 301 to 304. The electrical connection point 301 may be arranged in the gap 203 between a 6 o'clock direction and a 9 o'clock direction. The electrical connection point 302 may be arranged in the gap 203 between the 6 o'clock direction and a 3 o'clock direction. The electrical connection point 303 may be arranged in the gap 203 between the 3 o'clock direction and a 12 o'clock direction. The electrical connection point 304 may be arranged in the gap 203 between the 12 o'clock direction and the 9 o'clock direction.

The electrical connection points 301 to 304 may include one feed point and at least one ground point. The feed point is configured to arrange a feed. When the antenna operates, the feed may feed in a feed signal to the bezel 201. In some implementations, a matching tuning component may be further arranged between the feed and the bezel to perform antenna port tuning and the like. For example, low capacitance (for example, capacitance less than 1.5 pF) may be arranged between the feed and the bezel 201.

The ground point may be used as a point through which a current on the bezel 201 flows back to the floor 202. In some implementations, for any ground point, one or more components such as capacitance/inductance may be further arranged between the bezel 201 and the floor 202, to tune antenna parameters such as port impedance. For example, the components such as the capacitance/inductance may be low-impedance matching components. Specifically, the components may be high capacitance (for example, capacitance greater than 2 pF), low inductance (for example, inductance less than 5 nH), zero ohm, or the like.

With arrangement of the feed point and the ground point, arrangement of the antenna is implemented. For example, an example in which a perimeter of the bezel 201 corresponds to 1λ is used, where λ is an operating wavelength. One feed point and two ground points may be arranged to implement excitation in a one-wavelength mode, so that a resonance generated by the antenna can cover an operating frequency band.

For example, an example in which the electrical connection point 301 is arranged as a feed point is used. That is, the feed is connected at the electrical connection point 301. 0.5 pF capacitance may be connected in series between the feed and the bezel 201.

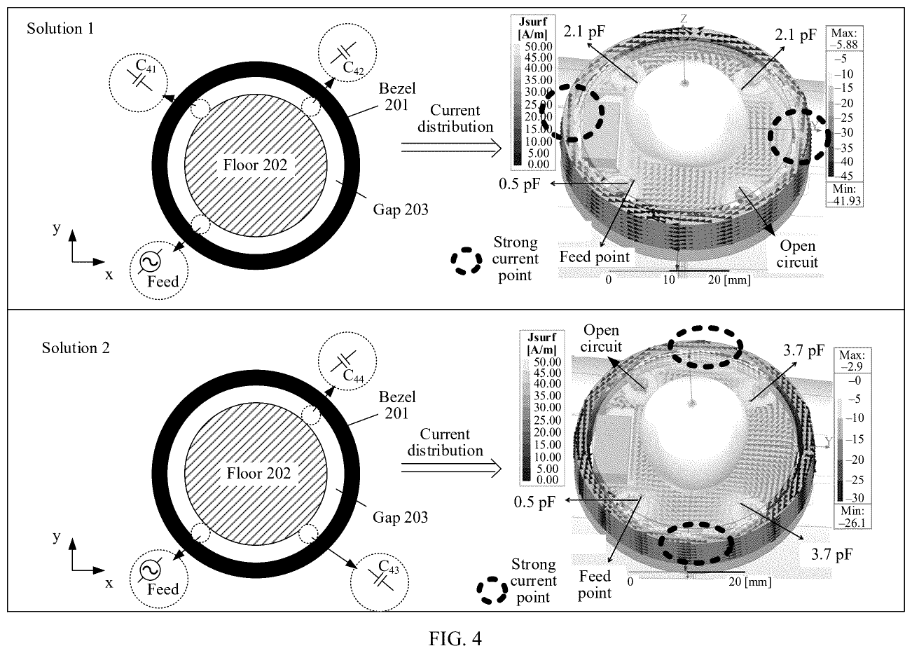

FIG. 4 shows two antenna arrangement solutions. In both Solution 1 and Solution 2 shown in FIG. 4, the antenna may operate at one wavelength to cover the operating frequency band.

In Solution 1, the ground point may be arranged between the electrical connection point 303 and the electrical connection point 304. There is an open circuit at the electrical connection point 302. For example, capacitance C₄₂ is arranged at the electrical connection point 303. One end of the capacitance C₄₂ is connected to the bezel 201. The other end of the capacitance C₄₂ is connected to the floor 202. Capacitance C₄₁ is arranged at the electrical connection point 304. One end of the capacitance C₄₁ is connected to the bezel 201. The other end of the capacitance C₄₁ is connected to the floor 202. In an example, the capacitance C₄₁ and the capacitance C₄₂ may be arranged to be 2.1 pF. Therefore, the operating frequency band (for example, a GPS frequency band) is covered.

In Solution 2, the ground point may be arranged between the electrical connection point 302 and the electrical connection point 303. There is an open circuit at the electrical connection point 304. For example, capacitance C₄₃ is arranged at the electrical connection point 302. One end of the capacitance C₄₃ is connected to the bezel 201. The other end of the capacitance C₄₃ is connected to the floor 202. Capacitance C₄₄ is arranged at the electrical connection point 303. One end of the capacitance C₄₄ is connected to the bezel 201. The other end of the capacitance C₄₄ is connected to the floor 202. In an example, the capacitance C₄₁ and the capacitance C₄₂ may be arranged to be 3.7 pF. Therefore, the operating frequency band (for example, a GPS frequency band) is covered.

FIG. 4 also shows distributions of strong current points in the two solutions during operation. A current in a darker color is weaker. On the contrary, a current in a lighter color is stronger. It may be understood that in the two solutions, since the ground point is arranged at different positions, the distributions of the strong current points on the bezel 201 during operation of the antenna are also different. An example in which the operating frequency band is covered by one wavelength is used. For Solution 1, an example in which both C₄₁ and C₄₂ are 2.1 pF is used, and it can be learned from current simulation shown in FIG. 4 that the strong current points on the bezel 201 are distributed positions close to 3 o'clock and the 9 o'clock. For Solution 2, an example in which both C₄₃ and C₄₄ are 3.7 pF is used, and it can be learned from current simulation shown in FIG. 4 that the strong current points on the bezel 201 are distributed at positions close to 12 o'clock and 6 o'clock.

It should be understood that the smartwatch is worn on the wrist of the user in most usage scenarios. The forearm of the user is very close to the smartwatch. Therefore, when the antenna is arranged, impact of the forearm on the antenna in the smartwatch needs attention. To simulate a scenario in which the smartwatch is worn on the wrist of the user, performance of the antenna may be evaluated with a forearm model. For example, the antenna is assembled on the forearm model to test efficiency of the antenna. The forearm model may be a standard forearm model, for example, a forearm model published by the Cellular Telecommunications Industry Association (Cellular Telecommunications Industry Association, CTIA). In the following description, a test performed by assembling the antenna on the forearm model may also be referred to as a test in a forearm mode, a worn mode, or the worn state.

In the worn mode, with reference to a current simulation example in FIG. 4, in Solution 1, the strong current point is close to the forearm, so that the impact of the forearm on radiation of the antenna in Solution 1 is significant. Correspondingly, in Solution 2, the strong current point is away from the forearm, so that the impact of the forearm on radiation of the antenna in Solution 2 is low.

With reference to simulation results in the two solutions, from the angle of radiation efficiency, in a 1575 MHz free space, the radiation efficiency in Solution 1 is −1.95 dB, and the radiation efficiency in Solution 2 is −2.09 dB. There is no significant difference between the radiation efficiency in the two solutions. In the worn mode, efficiency at 1575 MHz in Solution 1 is −11.09 dB, reduced by about 9 dB, and efficiency at 1575 MHz in Solution 2 is −8.50 dB, reduced by about 6.4 dB. It can be learned that the impact of the forearm in Solution 1 is significantly greater than that in Solution 2.

Therefore, Solution 2 in which the impact of the forearm is lower may be used to implement optimization of the antenna in the smartwatch.

However, reducing a reduction degree of the performance in the worn mode through the solution of adjusting the strong current point away from the forearm is still limited in antenna performance optimization. According to the antenna solution provided in this embodiment of this application, a magnetic field distribution in a space around the antenna during operation is optimized. In this way, absorption of radiation of the antenna by a human body is reduced, that is, the reduction degree of the performance of the antenna in the worn mode is reduced. Therefore, radiation performance of the antenna in the worn mode is improved.

The solution provided in this embodiment of this application is described below in detail with reference to the accompanying drawings.

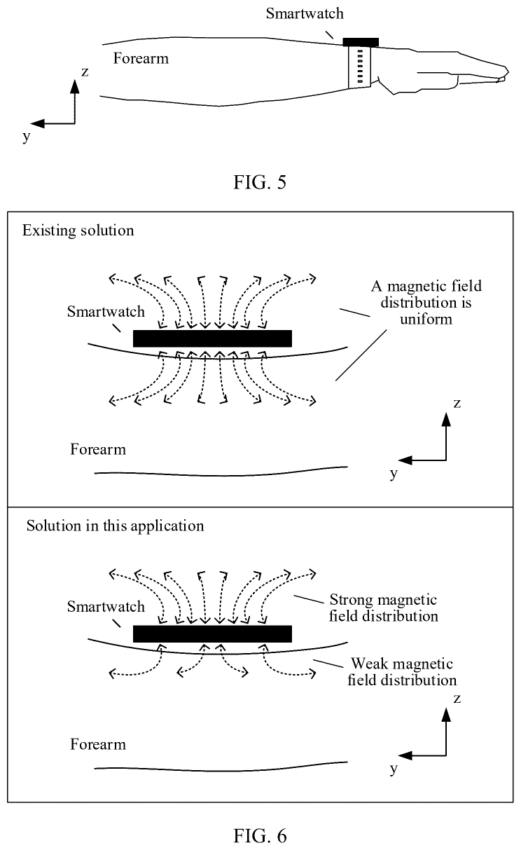

It should be understood that the antenna may convert an energy signal into an electromagnetic wave in the space for radiation. The electromagnetic wave may have an electrical characteristic and a magnetic characteristic. As shown in FIG. 5, a magnetic field is used as an example. When the magnetic field is close to the human body, since the human body is not a good conductor, an induced current generated on a surface of the human body is not enough. As a result, the magnetic field directly enters the human body at a high intensity. After the magnetic field enters the human body, since a magnetic field and an electric field in an electromagnetic field may be converted into each other, the magnetic field entering the human body may be converted into an electric field. The electric field has a great loss in the human body. As a result, energy of the electric field is weakened, affecting the radiation performance of the antenna.

Therefore, under a same condition, if the magnetic field that is in the electromagnetic wave emitted by the antenna and that is on a side close to the human body is weaker, energy of the magnetic field entering the human body is less, and correspondingly, conversion into the electric field causes a lower loss of the electromagnetic wave. That is, a magnetic field distribution around the antenna can be adjusted to set a magnetic field distribution in the space on the side close to the human body to a weak magnetic field, to effectively reduce a loss of radiation of the antenna caused by the human body (for example, the forearm).

Correspondingly, in the smart wearable device, the magnetic field distribution on the side close to the human body can be weakened, to reduce the performance loss in the worn mode and improve the performance of the antenna.

According to the antenna solution provided in this embodiment of this application, based on the foregoing principle, a parasitic ring structure is arranged to adjust the magnetic field on the side close to the forearm. Therefore, radiation effects shown in FIG. 6 are achieved. That is, a weak magnetic field distribution is obtained on the side close to the forearm, and a strong magnetic field distribution is obtained on a side away from the forearm. FIG. 6 also shows a magnetic field distribution of the antenna in the worn mode in an existing solution for comparison. It can be learned that in the existing solution, a magnetic field distribution nearby the antenna (for example, on the side close to the forearm and the side away from the forearm) is uniform. Therefore, with application of the solution provided in this embodiment of this application, the reduction degree of the performance in the worn mode is lower than that in the existing solution, achieving higher antenna performance.

With reference to the foregoing description, the antenna solution provided in this embodiment of this application is applicable to the smart wearable device and used for supporting the wireless communication function of the smart wearable device. For example, the smart wearable device may be a device such as the smartwatch or a smart bracelet. It should be understood that according to the antenna solution provided in this embodiment of this application, absorption of radiation of the antenna by the human body can be effectively reduced, so that the radiation performance of the antenna is improved. Therefore, the antenna solution is also applicable to another electronic device that may be used close to the human body. For example, the antenna solution is also applicable to a portable mobile device such as a mobile phone, a tablet computer, a personal digital assistant (personal digital assistant, PDA), an augmented reality (augmented reality, AR)\virtual reality (virtual reality, VR) device, or a media player.

A specific form of the device is not specially limited in embodiments of this application.

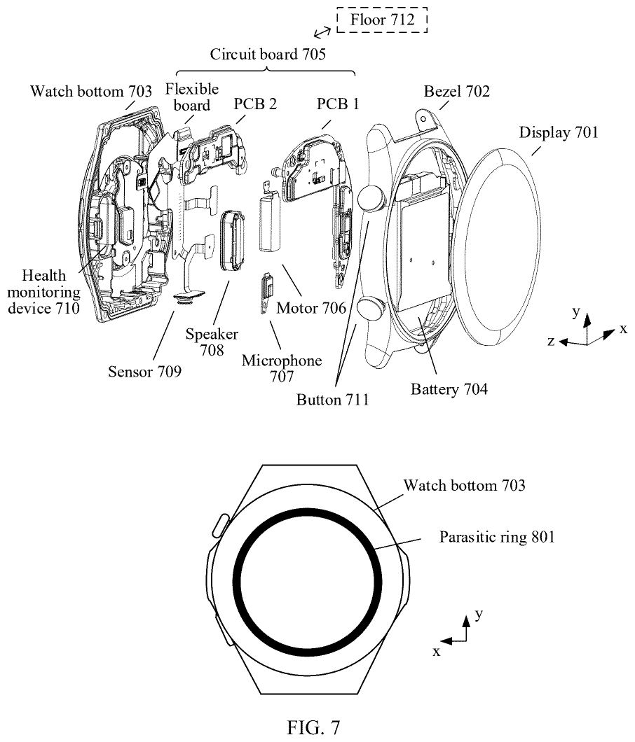

For example, FIG. 7 is a schematic diagram of composition of an electronic device 700 according to an embodiment of this application. The electronic device 700 may be a smartwatch.

As shown in FIG. 7, the electronic device 700 may include a display 701, a bezel 702, and a watch bottom 703. The display 701, the bezel 702, and the watch bottom 703 are assembled in sequence to obtain an appearance surface of the electronic device 700. Between the display 701 and the watch bottom 703, a plurality of structural/electronic components may be arranged inside the bezel 702. For example, the plurality of structural/electronic components may include a battery 704, one or more circuit boards 705, a motor 706, a microphone 707, a speaker 708, a sensor 709, and the like.

Brief introductions are separately provided below.

The display 701 is configured to display an image, a video, and the like. The display 701 includes a display panel. The display panel may be a liquid crystal display 701 (liquid crystal display, LCD), an organic light-emitting diode (organic light-emitting diode, OLED), an active-matrix organic light-emitting diode (active-matrix organic light-emitting diode, AMOLED), a flexible light-emitting diode (flex light-emitting diode, FLED), a mini-LED, a micro-LED, a micro-OLED, a quantum dot light-emitting diode (quantum dot light-emitting diode, QLED), or the like. In some embodiments, the electronic device 700 may include one or more displays 701. In different implementations, a shape of the display 701 may be circular, square, rectangular, or the like.

The bezel 702 is configured to provide a support in directions around a watch body (for example, directions x and y). The bezel 702 may include a closed ring structure made of a metal material. The metal material may include low-carbon steel, aviation aluminum, high-strength aluminum alloy, stainless steel, titanium alloy, and the like. In some implementations, the bezel 702 may further include a non-metal material. For example, at least part of the closed ring made of metal is wrapped with materials such as plastics and ceramics to implement individual appearance configuration of the bezel 702. Corresponding to different designs, the bezel 702 may be circular, square, rectangular, or the like. For example, the bezel 702 may alternatively be implemented through an in-mold injection molding process. For example, a metal skeleton is prepared through die casting, and plastics is injected on an outer side of the metal skeleton to obtain a complete bezel 702. In this example, the metal skeleton in the bezel 702 may correspond to the closed ring structure made of the metal material in the bezel 702 above. It should be noted that in some other embodiments of this application, the ring structure made of the metal material in the bezel 702 may alternatively be non-closed. For example, one or more openings are provided on the ring structure.

In some implementations, one or more buttons 711 may be provided on an outer side of the bezel 702. The button 711 may be used as a physical input component. The button 711 may receive operations such as pressing, long pressing, and/or rotation, and implement functions such as power on/off adjustment, volume adjustment, and time adjustment. The button 711 may be a mechanical button 711 or a touch button 711.

The watch bottom 703 is a bottom support of the electronic device 700. The watch bottom 703 may include a non-metal material, such as plastics, fiberglass, and/or ceramics. In some implementations, the watch bottom 703 may further include a metal material, such as low-carbon steel, aviation aluminum, high-strength aluminum alloy, stainless steel, and/or titanium alloy. In some implementations, to provide better wearing comfort and improve a degree of fit between the bezel 702 and the watch bottom 703, a gap between the bezel 702 and the watch bottom 703 may be filled with the non-metal material through a process such as injection molding.

The one or more circuit boards 705 may be provided inside the electronic device 700. In this example, as shown in FIG. 7, the circuit board 705 may include a PCB 1, a PCB 2, and a flexible board. The plurality of circuit boards 705 may be connected through an electronic circuit to implement signal interaction. Specific implementations of different circuit boards 705 may be different. For example, the circuit board 705 may include an FPC, referred to as a flexible board, and a PCB.

The circuit board 705 may be used as a carrier of the electronic component and the electronic circuit. For example, a processor may be arranged on the circuit board 705. The processor may include one or more processing units. For example, the processor may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU). Different processing units may be separate devices, or may be integrated into one or more processors. The processor may generate an operation control signal based on an instruction operation code and a timing signal, to implement control on instruction fetching and execution. A memory may be further arranged in the processor and configured to store instructions and data. In some embodiments, the memory in the processor may be a cache. The memory may store instructions or data that has been used by the processor or that is used at a high frequency. If the processor needs to use the instructions or the data, the processor may directly invoke the instructions or the data from the memory. This avoids repeated access, and reduces a waiting time of the processor, thereby improving system efficiency. In some embodiments, the processor may be a microprocessor unit (Microprocessor Unit, MPU) or a microcontroller unit (Microcontroller Unit, MCU).

A communication module such as a radio frequency module may also be arranged on the circuit board 705. The radio frequency module is connected to a baseband processor through a baseband line. The radio frequency module may also be connected to an antenna, to implement a wireless communication function. For example, during signal transmission, the baseband processor sends a digital signal to the radio frequency module through the baseband line, and the radio frequency module converts and processes the digital signal to obtain a corresponding analog signal. The radio frequency module transmits the analog signal to the antenna, so that the antenna converts the analog signal into an electromagnetic wave to radiate outward. During signal reception, the antenna converts the electromagnetic wave into an analog signal carrying information and transmits the analog signal to the radio frequency module. The radio frequency module converts the analog signal into a digital signal after radio-frequency domain processing, and transmits the digital signal to the baseband processor. The baseband processor parses the digital signal to obtain information carried in the received signal.

With reference to the description in FIG. 2, in the example shown in FIG. 7, the circuit board 705 may provide a zero potential reference for each electronic component. For example, in some logic implementations, the circuit board 705 may be used as a reference ground of the antenna. In the following description of this application, a reference ground function of the circuit board 705 is abstracted as a floor 712 for illustration. Certainly, in some other embodiments, when the watch bottom 703 includes at least part of metal, the watch bottom 703 may cooperate with the floor 712 corresponding to the circuit board 705, or the watch bottom 703 may be used independently as the floor 712.

In this embodiment of this application, the bezel 702 may be configured to cooperate with the floor 712 to implement arrangement of the antenna. For example, the bezel 702 is used as part of an antenna radiator, and the floor 712 is used as the reference ground of the antenna. For another example, a gap between the bezel 702 and the floor 712 may form a slot antenna to support the wireless communication function of the electronic device 700.

In this application, a parasitic ring structure may be further arranged nearby the bezel 702 and/or the floor 712. The parasitic ring structure may be a continuous or discontinuous metal ring body. From the angle of a tangent plane of an xoz plane or a yoz plane, in some implementations, the parasitic ring structure may be arranged in the gap between the bezel 702 and the floor 712. In some other implementations, at least part of the parasitic ring structure may be arranged in a z-direction projection region of the floor 712. In some other implementations, at least part of the parasitic ring structure may be arranged in a z-direction projection region of the bezel 702. From the angle of an xoy plane, in some embodiments, with reference to a back view on the xoy plane shown in FIG. 7, the parasitic ring structure (that is, a parasitic ring 801 shown in FIG. 7) may be arranged on an outer surface of the watch bottom 703. In this way, when the electronic device 700 is in a worn state, the parasitic ring 801 may be located between the floor 721 and/or the bezel 702 and a forearm. In some other embodiments, the parasitic ring structure may alternatively be arranged inside the watch bottom 703. For example, when the watch bottom 703 is made of the non-metal material, the parasitic ring structure made of a metal material may be embedded inside the watch bottom 703 through an injection molding process. Similar to the foregoing example, even though the parasitic ring structure is arranged inside the watch bottom 703 and cannot be seen from the outside, when the electronic device 700 is in the worn state, the parasitic ring structure may also be located between the floor 721 and/or the bezel 702 and the forearm.

The battery 704 is arranged inside the electronic device 700. The battery 704 is configured to supply power to the electronic device 700.

The components of the electronic device 700 such as the motor 706, the microphone 707, and the speaker 708 may be connected to the circuit board 705 separately, so that the processor on the circuit board 705 controls the corresponding components to implement corresponding functions. The motor 706 may be configured to generate a vibration prompt. The motor 706 may be configured for vibration alerts for incoming calls, and may be further configured for touch vibration feedback. The microphone 707, also referred to as a “mouthpiece” or a “megaphone”, is configured to convert a sound signal into an electrical signal. When making a call or sending voice information, a user may speak with the mouth approaching the microphone 707, to input a sound signal to the microphone 707. The electronic device 700 may be provided with at least one microphone 707. The speaker 708, also referred to as a “horn”, is configured to convert an audio electrical signal into a sound signal. The electronic device 700 may emit music through the speaker 708, or output an audio signal for a hands-free call.

One or more sensors 709 may be further arranged on the circuit board 705, such as a pressure sensor, a gyro sensor, a magnetic sensor, an acceleration sensor, an optical proximity sensor, a fingerprint sensor, and a touch sensor. Different sensors 709 may be configured to support various functions of the electronic device 700. For example, the pressure sensor and/or the touch sensor may cooperate with the display 701 to implement a touch control function.

The electronic device 700 may be further provided with a health monitoring device 710, such as a heart rate monitoring module or a blood pressure detection module. The health monitoring device 710 may be configured to detect a health sign of the user, and provide obtained related data for the processor of the electronic device 700 or transmit obtained related data to another electronic device 700 for processing, to achieve health detection effects.

The antenna solution provided in this embodiment of this application is applicable to the electronic device 700 shown in FIG. 7. It should be noted that the composition in FIG. 7 is merely an example, and does not constitute a limitation on the electronic device 700. In some other embodiments, the electronic device 700 may further include more or fewer components. Specific composition of the electronic device 700 is not limited in this embodiment of this application.

The antenna solution provided in this embodiment of this application is described below in detail. An example in which the antenna solution is applied to a smartwatch (referred to as a watch) is used.

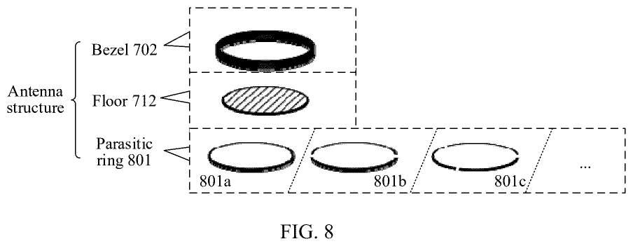

With reference to FIG. 7, refer to FIG. 8. An antenna structure provided in an embodiment of this application may include the bezel 702 and the floor 712. The antenna structure may be further provided with the parasitic ring 801 (that is, corresponding to the parasitic ring structure in the foregoing description). It should be noted that with reference to the foregoing example, the floor 712 may be a logical structure, and may specifically correspond to one or more components that are in the watch and that can provide zero potential references. For example, the floor 712 may include the plurality of circuit boards 705 shown in FIG. 7. In the following example, an example in which a circular structure shown in FIG. 8 schematically identifies the floor 712 is used for description.

The parasitic ring 801 may be a hollow ring structure made of a metal material. For example, the metal material may include low-carbon steel, aviation aluminum, high-strength aluminum alloy, stainless steel, and titanium alloy. For another example, the parasitic ring 801 may alternatively be arranged in the watch through a laser direct structuring (Laser Direct Structuring, LDS) process or a printing direct structuring (Printing Direct Structuring, PDS) process. In this manner, a material of the parasitic ring 801 may correspond to a metal material such as silver or copper corresponding to the LDS process or the PDS process. The ring structure may be a circle, a square, a polygon, or another ring structure. A shape of the parasitic ring is not limited to the foregoing shapes. Any shape that is hollow in middle and that is substantially a ring falls within the scope of the ring structure claimed by the present invention. In addition, the parasitic ring structure is not limited to the closed ring structure, and further includes a ring structure with a plurality of openings in middle. In some embodiments, the shape of the parasitic ring 801 may be the same as or similar to those/that of the bezel 702 and/or the floor 712, to facilitate assembling. In addition, a magnetic field can also be adjusted based on structural symmetry of the entire antenna. In the following example, an example in which both the bezel 702 and the parasitic ring 801 are ring structures and the floor 712 is circular is used. It should be understood that the floor 712 is obtained by abstracting components such as the circuit board 705, so that the shape of the floor 712 may not be fixed, for example, may be a shape other than a circle. In case of different shapes and structures, reference may be made between solution implementations with the parasitic ring 801 added in this embodiment of this application.

The parasitic ring 801 may be arranged nearby the bezel 702 and the floor 712. From the angle of the entire watch, the parasitic ring 801 may be arranged at a position close to or on the back of the watch. Therefore, in a worn mode, the parasitic ring 801 may be located close to the forearm. For example, a watch bottom is made of a plastic material. The parasitic ring 801 may be arranged on the plastic watch bottom. Alternatively, the parasitic ring 801 may be arranged inside the plastic watch bottom in an injection molding form.

When the antenna operates, the parasitic ring 801 is configured to generate a current opposite to that on the bezel 702 or the floor 712 close to the parasitic ring 801 during operation of the antenna. A magnetic field generated by the opposite current on the parasitic ring 801 may be partly counteracted by a magnetic field generated by the current on the bezel 702 or the floor 712 close to the parasitic ring 801.

In this case, since the parasitic ring 801 is located close to the forearm, a region in which the magnetic fields are counteracted is a region on a side close to the forearm during radiation of the antenna in the watch. With reference to the description in FIG. 6, according to the antenna solution provided in this embodiment of this application, absorption of radiation of the antenna by the forearm can be effectively reduced, so that the overall radiation performance of the antenna is improved.

It should be noted that specific implementations of the parasitic ring 801 in different implementations may be different. For example, in some embodiments, the parasitic ring 801 may be a closed hollow ring structure shown in 801a in FIG. 8. In some other embodiments, the parasitic ring 801 may be a ring structure with one or more openings. For example, an example in which the parasitic ring 801 is provided with two openings is used. 801b in FIG. 8 shows an example of a ring structure including two openings that are opposite. 801c in FIG. 8 shows an example of a ring structure including three openings that are opposite. In some other embodiments, the parasitic ring 801 may be provided with more openings. The opening of the parasitic ring 801 may be set to a size of 0.2 mm to 1.5 mm in different implementations. For example, the size of the opening of the parasitic ring 801 may be set to about 1 mm. In different implementations, the size of the opening of the parasitic ring 801 can be adjusted to adjust a branch length of the parasitic ring 801, so that a mode excited on the parasitic ring 801 can fall within a required operating frequency band.

In this embodiment of this application, provision of the opening on the parasitic ring 801 may be related to a current distribution on the bezel 702. It should be understood that the bezel 702 may implement excitation in different modes under excitation of a feed, for example, a mode in which a perimeter L of the bezel 702 is a ½ wavelength, a mode in which L is one wavelength (that is, a 2/2-wavelength mode), and a mode in which L is a 3/2 wavelength. In some embodiments, when the ½ wavelength is excited on the bezel 702, one weak current point and one strong current point may be distributed on the bezel 702. In this case, the parasitic ring 801 may be correspondingly provided with one opening. The opening may be provided close to the weak current point. In some other embodiments, when the one-wavelength mode is excited on the bezel 702, two weak current point and two strong current points may be distributed on the bezel 702. In this case, the parasitic ring 801 may be correspondingly provided with two openings. The two openings may be provided close to the two weak current points respectively. The rest may be deduced by analogy. When an N/2-wavelength mode is excited on the bezel 702, N weak current points may be distributed on the bezel 702. In this case, the parasitic ring 801 may be provided with N openings. The N openings may be provided close to the N weak current points respectively.

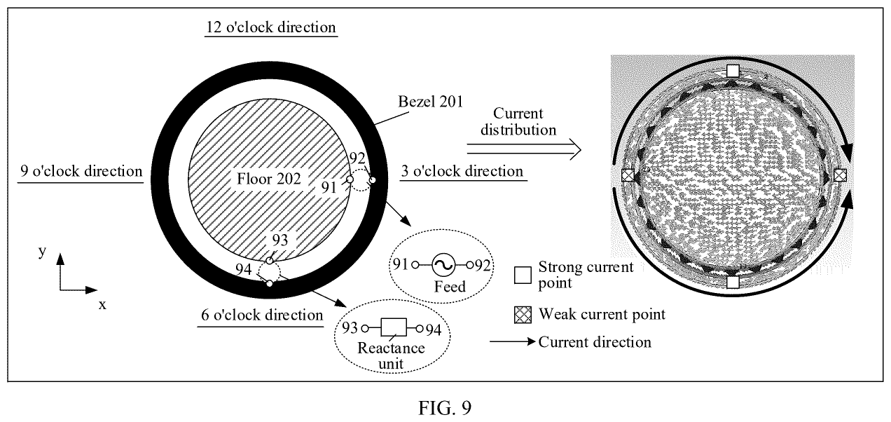

For example, refer to FIG. 9. A feed point is arranged in a 3 o'clock direction and connected to the feed, and a ground point is arranged in a 6 o'clock direction. In this case, the one-wavelength mode is used as an example. The strong current point may be distributed nearby 12 o'clock and 6 o'clock, and the weak current point may be distributed nearby 3 o'clock and 9 o'clock. The parasitic ring 801 arranged in this case may include two openings. The two openings may be arranged nearby 3 o'clock and 9 o'clock of the parasitic ring 801 respectively. In some implementations, a matching device may be arranged on the feed and/or a ground path. For example, as shown in FIG. 9, a reactance unit is arranged at the ground point. The reactance unit may include a low-impedance device (for example, high capacitance, low inductance, or zero ohm). For another example, low capacitance (for example, about 1 pF) may be connected to a link at the feed.

In addition, from the angle of a relative positional relationship between the parasitic ring 801 and the bezel 702 and the floor 712, the parasitic ring 801 may be arranged flexibly.

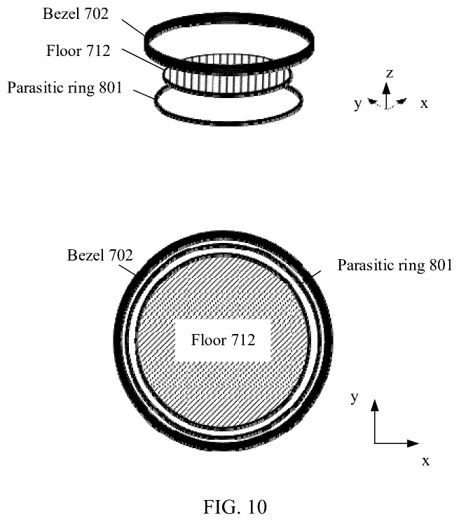

For example, in some embodiments, the parasitic ring 801 may be arranged in a region close to the bezel 702. For example, refer to FIG. 10. The parasitic ring 801 may be arranged in a gap between the bezel 702 and the floor 712. In this way, an internal diameter of the parasitic ring 801 may be greater than a diameter of the floor 712. In addition, an external diameter of the parasitic ring 801 may be less than that of the bezel 702.

In this example, the parasitic ring 801 is arranged close to the bezel 702. When the antenna operates, a direction of a current generated on the parasitic ring 801 may be opposite to that of a current on the bezel 702. For example, FIG. 11 is a sectional view during operation of the antenna. FIG. 11 shows a current distribution on a radiator (for example, the bezel 702, the floor 712, and the parasitic ring 801) during operation of the antenna and a respectively corresponding magnetic field distribution. As shown in FIG. 11, a current flowing inward perpendicular to paper may be distributed on the bezel 702 on both sides separately, and correspondingly, the current on the floor 712 flows outward perpendicular to the paper. That is, the currents flow in opposite directions on the bezel 702 and the floor 712. In this case, directions of magnetic fields generated by the currents are different. For example, a clockwise magnetic field may be distributed around the bezel 702, that is, a magnetic induction line is clockwise. Correspondingly, an anticlockwise magnetic field may be distributed around the floor 712, that is, a magnetic induction line is anticlockwise. As shown in FIG. 11, in this example, a current may also be distributed on the parasitic ring 801. Since the parasitic ring 801 is distributed close to the bezel 702, the current on the parasitic ring 801 may be generated mainly through the bezel 702 in a coupling manner. A current direction on the parasitic ring 801 may be opposite to that on the bezel 702 and the same as that on the floor 712. For example, a current flowing outward perpendicular to the paper may be distributed on the parasitic ring 801. In this case, a direction of a magnetic field generated by the current on the parasitic ring 801 may be anticlockwise. This direction is opposite to that of a magnetic field generated by a surface current of the bezel 702. Therefore, weakening adjustment can be implemented on the magnetic field on the bezel 702. Therefore, the magnetic field generated on the bezel 702 is weakened on the side close to the forearm. Corresponding to a loss caused by the forearm, this reduces a loss of radiation of the antenna caused by the forearm, and improves radiation performance of the antenna.

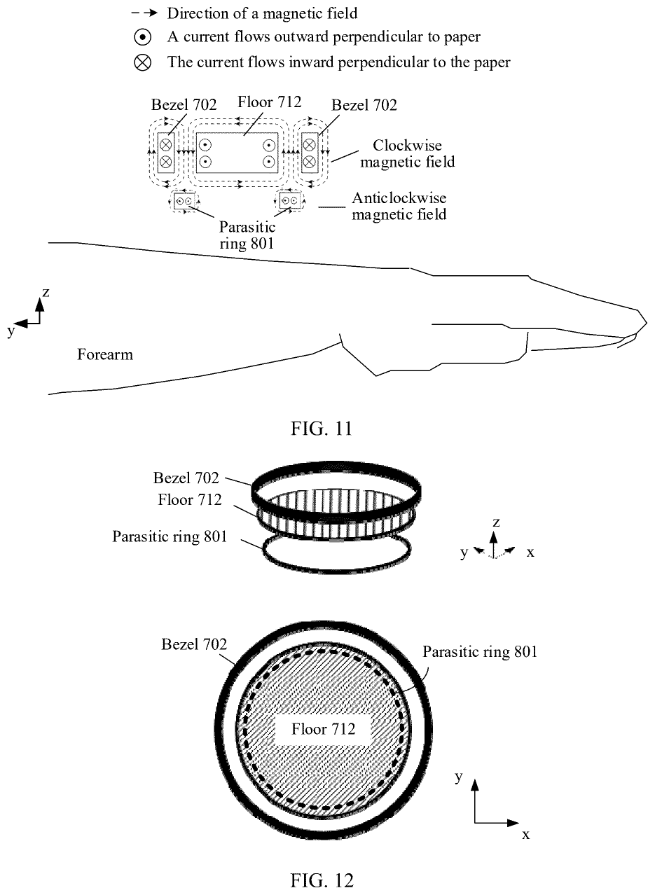

In some other embodiments, the parasitic ring 801 may be arranged in a region close to the floor 712. For example, refer to FIG. 12. The parasitic ring 801 may be arranged in a z-direction projection region of the floor 712. For example, the parasitic ring 801 may be arranged below the floor 712. In this way, an external diameter of the parasitic ring 801 may be less than a diameter of the floor 712.

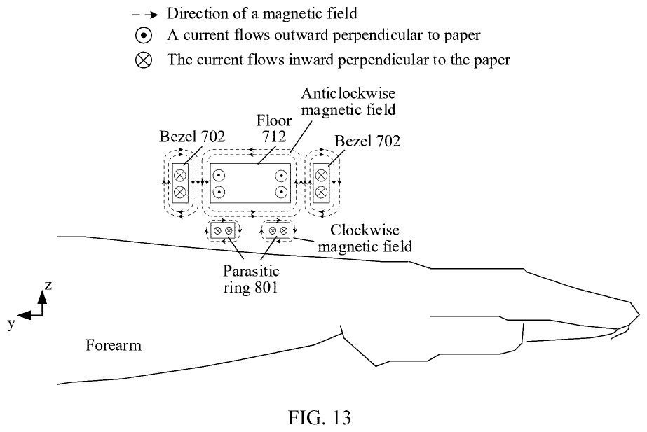

In this example, the parasitic ring 801 is arranged close to the floor 712. When the antenna operates, a direction of a current generated on the parasitic ring 801 may be opposite to that of a current on the floor 712. For example, FIG. 13 is a sectional view during operation of the antenna. The figure shows a current distribution on a radiator (for example, the bezel 702, the floor 712, and the parasitic ring 801) during operation of the antenna and a respectively corresponding magnetic field distribution. As shown in FIG. 13, a current flowing inward perpendicular to paper may be distributed on the bezel 702 on both sides respectively, and correspondingly, the current on the floor 712 flows outward perpendicular to the paper. That is, the currents flow in opposite directions on the bezel 702 and the floor 712. In this case, directions of magnetic fields generated by the currents are different. For example, a clockwise magnetic field may be distributed around the bezel 702, that is, a magnetic induction line is clockwise. Correspondingly, an anticlockwise magnetic field may be distributed around the floor 712, that is, a magnetic induction line is anticlockwise. As shown in FIG. 13, a current may also be distributed on the parasitic ring 801. Since the parasitic ring 801 is distributed close to the floor 712, different from the example in FIG. 11, in this example, the current on the parasitic ring 801 may be generated mainly through the floor 712 in a coupling manner. A direction of the current on the parasitic ring 801 may be opposite to that on the floor 712 and the same as that on the bezel 702. For example, a current flowing inward perpendicular to the paper may be distributed on the parasitic ring 801. In this case, a direction of a magnetic field generated by the current on the parasitic ring 801 may be clockwise. This direction is opposite to that of a magnetic field generated by a surface current of the floor 712. Therefore, weakening adjustment can be implemented on the magnetic field on the floor 712. Therefore, the magnetic field generated on the floor 712 is weakened on the side close to the forearm. Corresponding to a loss caused by the forearm, this reduces a loss of radiation of the antenna caused by the forearm, and improves radiation performance of the antenna.

It should be noted that when the antenna in the watch operates, although the floor 712 may play a role of a reference ground, since a size of the floor 712 does not greatly differ from that of the bezel 702, the floor 712 may also participate in radiation of the antenna. That is, the floor 712 may also play a role of an antenna radiator. Therefore, weakening the magnetic field on the side close to the forearm during radiation of the floor 712 through the parasitic ring 801 can achieve effects of reducing a loss caused by a human body and improving the radiation performance of the antenna.

The antenna solution provided in this embodiment of this application continues to be described below with reference to specific examples and related simulation results. An example in which arrangement of the feed point and the ground point is the same as that in the example in FIG. 9 is used. It should be understood that when arrangement of the feed point and/or the ground point is different from that in the example in FIG. 9, for a corresponding arrangement manner of the parasitic ring 801 and corresponding effects, reference may be made to this example, and details are not described again.

First, an example in which the one-wavelength mode is excited on the bezel 702 to cover the operating frequency band is used. In this case, with reference to the description in FIG. 8, the parasitic ring 801 may be provided with two openings close to the weak current points on the bezel 702 respectively. With reference to the solution example in FIG. 9, when the feed point is arranged nearby 3 o'clock, and the ground point is arranged nearby 6 o'clock, the weak current points may be distributed nearby 3 o'clock and 9 o'clock of the bezel 702. In this case, the two openings of the parasitic ring 801 may be provided nearby 3 o'clock and 9 o'clock of the parasitic ring 801 respectively.

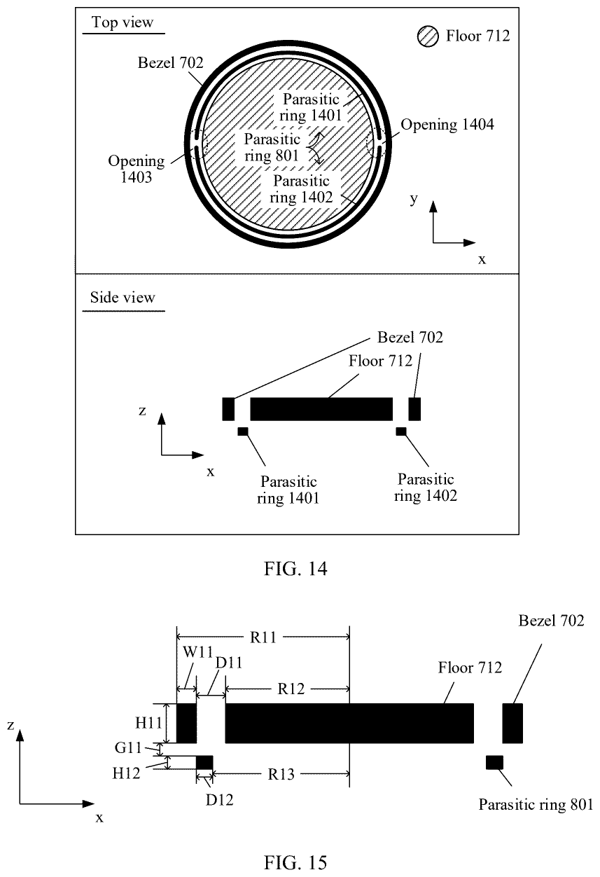

FIG. 14 is a schematic diagram of an antenna solution according to an embodiment of this application. In this example, the parasitic ring 801 is arranged at a position close to the bezel 702. For example, a projection of the parasitic ring 801 may fall in the gap between the bezel 702 and the floor 712. In this case, for an operation mechanism of the antenna solution in this example, reference may be made to the description in FIG. 10 or FIG. 11.

For example, as shown in a top view in FIG. 14, the ring structure of the parasitic ring 801 may include two openings, for example, an opening 1404 provided at a 3 o'clock position and an opening 1403 provided at a 9 o'clock position. The two openings may divide the ring structure of the parasitic ring 801 into two parts that are disconnected from each other, for example, an upper half of the parasitic ring 801 (that is, a parasitic ring 1401) and a lower half of the parasitic ring 801 (that is, a parasitic ring 1402). In some embodiments, the parasitic ring 1401 and the parasitic ring 1402 may be arranged symmetrically about a central point connecting line of the opening 1403 and the opening 1404.

Continue to refer to a side view in FIG. 14. A tangent plane of the side view may be a tangent plane of yoz passing through a geometrical center of an xoy plane of the watch. It can be learned from the side view that z-direction projections of the parasitic ring 1401 and the parasitic ring 1402 may fall in the gap between the bezel 702 and the floor 712. This may be regarded as the parasitic ring 801 being arranged close to the bezel 702.

An operation situation of the antenna is described below with reference to the structure shown in FIG. 14. The side view shown in FIG. 14 is used as an example. FIG. 15 shows related dimensioning and descriptions of the antenna structure. An outer radius of the bezel 702 may be R11. An x-direction width of the bezel 702 may be W11. A z-direction height of the bezel 702 may be H11. A radius of the floor 712 may be R12. A width of the gap between the floor 712 and the bezel 702 may be D11. An inner radius of the parasitic ring 801 may be R13. An x-direction width of the parasitic ring 801 may be D12. A z-direction height of the parasitic ring 801 may be H12. In this example, the parasitic ring 801 may be located on a different plane from the bezel 702 and the floor 712. For example, a z-direction distance between the parasitic ring 801 and the bezel 702 may be G11. In an example, in the following simulation, an example in which R11=23 mm, R12=19.5 mm, W11=1.5 mm, D11=2 mm, H11=5 mm, R13=20 mm, D12=1.5 mm, G11=2 mm, H12=0.1 mm, and widths of the two openings of the parasitic ring 801 are both 0.5 mm is used. An operation situation of the antenna structure shown in FIG. 14 is described with reference to current and S parameter simulation.

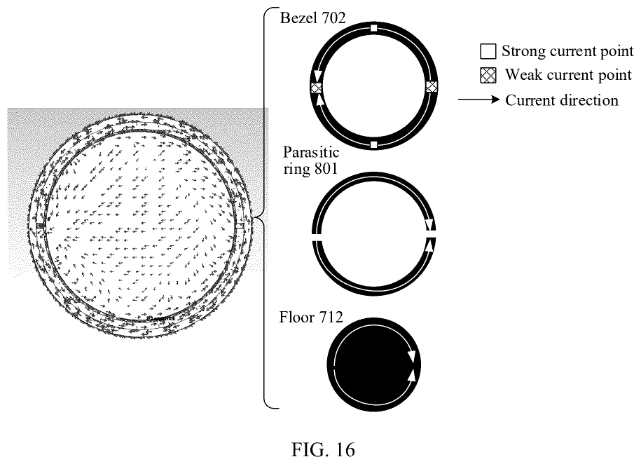

FIG. 16 shows a current distribution of each component during operation of the antenna of the structure shown in FIG. 14. For a clearer description, FIG. 16 also shows logical illustration of the current distribution on each component.

In this example, the current on the bezel 702 may flow from the weak current point nearby 3 o'clock to the weak current point nearby 9 o'clock. The strong current points are distributed in the 12 o'clock direction and the 6 o'clock direction. The direction of the current on the floor 712 is opposite to that of the current on the bezel 702, and a strong current point and a weak current point are distributed in a similar manner. For example, the current on the floor 712 may flow from the weak current point nearby 9 o'clock to the weak current point nearby 3 o'clock. Due to a skin effect of the current, a significant current on the floor 712 is distributed on an edge of the floor 712 in an arched manner. With reference to the illustration in FIG. 9, the current distribution coincides with the description in FIG. 9.

As shown in FIG. 16, the direction of the current on the parasitic ring 801 arranged close to the bezel 702 may be opposite to that on the bezel 702 and consistent with that on the floor 712. For example, the current on the parasitic ring 801 may flow from the opening provided at 9 o'clock and the opening provided at 3 o'clock.

In this case, since the direction of the current on the parasitic ring 801 is opposite to that of the current on the bezel 702, directions of magnetic fields generated by the currents respectively are opposite, and the magnetic fields may be counteracted in a space close to the forearm. Therefore, weakening adjustment is implemented on the magnetic field generated on the bezel 702. Therefore, an intensity of the magnetic field radiated by the bezel 702 to the forearm is low, and a loss of a total radiation amount of the antenna caused by the forearm is correspondingly reduced. This achieves the effect of improving the radiation performance of the antenna.

The radiation performance of the antenna during operation in the worn mode is described below through S parameter simulation. An example in which the one-wavelength mode is excited on the antenna to cover a frequency band nearby 1575 MHz is used.

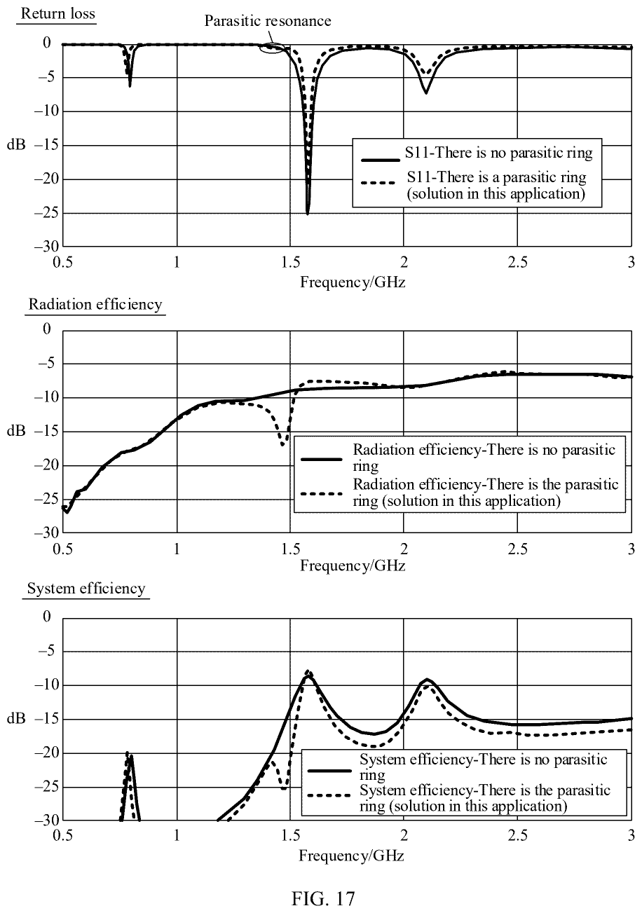

FIG. 17 is a schematic diagram of S parameter and efficiency simulation of the antenna having the composition shown in FIG. 16. As shown in FIG. 17, from the angle of a return loss (S11), after the design of the parasitic ring 801 is added, a resonance bandwidth in the frequency band nearby 1575 MHz is reduced to some extent. In addition, the antenna can excite a low resonance at a frequency position lower than a main resonance nearby 1575 MHz. The low resonance may correspond to a mode excited by the parasitic ring 801 after coupling. From the angle of radiation efficiency, after the design of the parasitic ring 801 is added, the radiation efficiency in the frequency band nearby the main resonance is significantly improved, with a peak exceeding −8 dB, more than 1 dB higher than that in a solution in which the design of the parasitic ring 801 is not added. From the angle of system efficiency, peak efficiency of the main resonance is also more than 1 dB higher than that in the solution in which the design of the parasitic ring 801 is not added. It should be understood that an operating frequency band generally used in the watch has a low bandwidth requirement. For example, the operating frequency band may include a GPS frequency band for positioning and a Bluetooth frequency band for Bluetooth connections. Therefore, simulation results shown in FIG. 17 show that although both S11 and an efficiency bandwidth are reduced to some extent, the effect of significantly improving the radiation performance can be achieved while the operating frequency band can be covered.

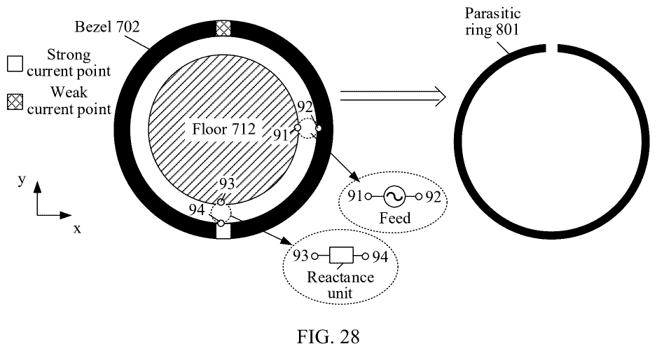

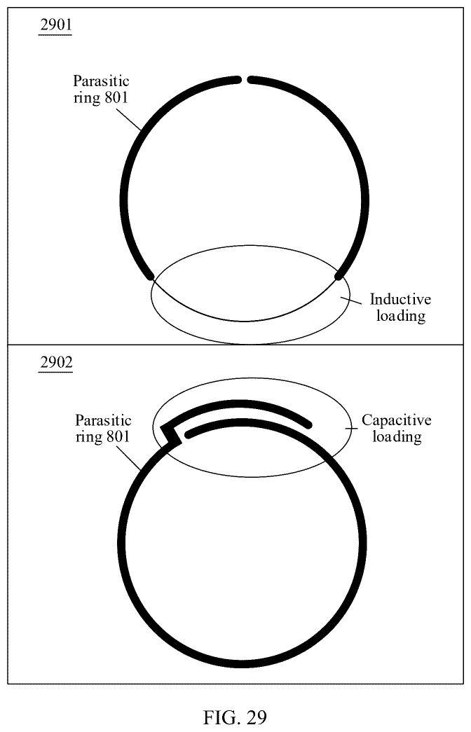

In the foregoing example, a parasitic resonance on a low-frequency side of the main resonance may be generated in a half-wavelength mode excited on the parasitic ring 801. In some other embodiments of this application, a half-wavelength mode excited on the parasitic ring 801 may alternatively be located on a high-frequency side of the main resonance through matching tuning or structural fine adjustment. A solution of adjusting a frequency band covered by the parasitic resonance is subsequently described in detail in FIG. 28 and FIG. 29. For example, the parasitic resonance may be adjusted through inductive loading and/or capacitive loading.

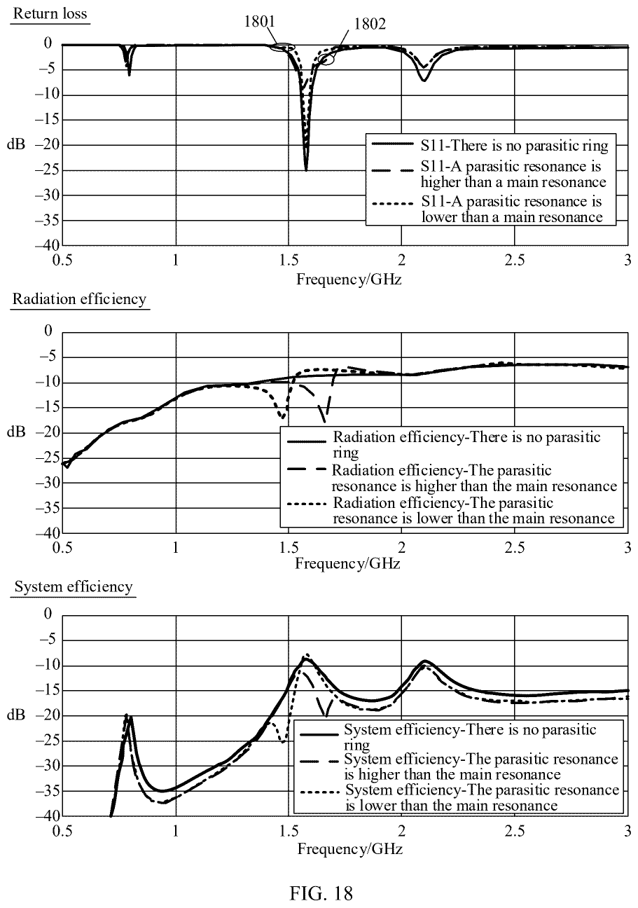

For example, FIG. 18 is a schematic diagram of S parameter and efficiency simulation when the parasitic resonance is located on the high-frequency side and the low-frequency side of the main resonance respectively. As shown in FIG. 18, from the angle of S11, when the parasitic resonance is located on the low-frequency side of the main resonance, the resonance may be identified as a parasitic resonance 1801. When the parasitic resonance is located on the high-frequency side of the main resonance, the resonance may be identified as a parasitic resonance 1802. When the parasitic resonance corresponds to the parasitic resonance 1802 on the high-frequency side, an overall depth of S11 is smaller than that in a case in which the parasitic resonance is located on the low-frequency side of the main resonance. This may be understood as that when the parasitic ring 801 is arranged nearby the bezel 702, if the parasitic resonance is tuned to the high-frequency side of the main resonance, the parasitic resonance is incompatible with the main resonance, and consequently, the parasitic resonance has specific impact on radiation of the main resonance. From the angle of the radiation efficiency, when the parasitic resonance is lower than the main resonance, corresponding radiation efficiency is significantly improved nearby 1575 MHz. For example, when the parasitic resonance is lower than the main resonance, the radiation frequency in an entire frequency band of the main resonance is higher than that in a case in which there is no parasitic ring 801. For another example, when the parasitic resonance is higher than the main resonance, the radiation efficiency on the high-frequency side of the main resonance is significantly higher than that in an entire frequency band of the main resonance. In this case, frequencies corresponding to the main resonance and the parasitic resonance may be appropriately tuned to make a position at which the radiation efficiency is higher than that of the main resonance fall in the operating frequency band, to implement efficient coverage of the operating frequency band. In addition, from the angle of the system efficiency, in case of current port matching, when the parasitic resonance is higher than the main resonance, since the parasitic resonance is incompatible with the main resonance, the system efficiency is reduced to some extent. However, with reference to the foregoing description, port matching may be adjusted to move the main resonance and the parasitic resonance on the high-frequency side to the low-frequency side in a unified manner, so that a part with high radiation efficiency covers the operating frequency band, to achieve high radiation performance.

In different implementations, a dielectric material between the parasitic ring 801 and the bezel 702 may be adjusted to implement dielectric loading with a material having an appropriate dielectric constant, to adjust a resonance position of the parasitic ring 801. In some other implementations, the structure of the parasitic ring 801 may be adjusted to adjust the position of the parasitic resonance.

In the example in FIG. 14 to FIG. 18, implementation of the solution in which the parasitic ring 801 is arranged nearby the bezel 702 in this application and operation effects are described. According to the antenna structure shown in FIG. 14, for example, when the parasitic resonance is tuned to the low-frequency side of the main resonance, the loss of the performance of the antenna caused by the forearm can be effectively reduced, and the radiation performance of the antenna in the worn mode can be improved.

Implementation of the solution in which the parasitic ring 801 is arranged nearby the floor 712 and operation effects continue to be described below with reference to the accompanying drawings. An example in which the z-direction projection of the parasitic ring 801 is within a range of the floor 712 is used.

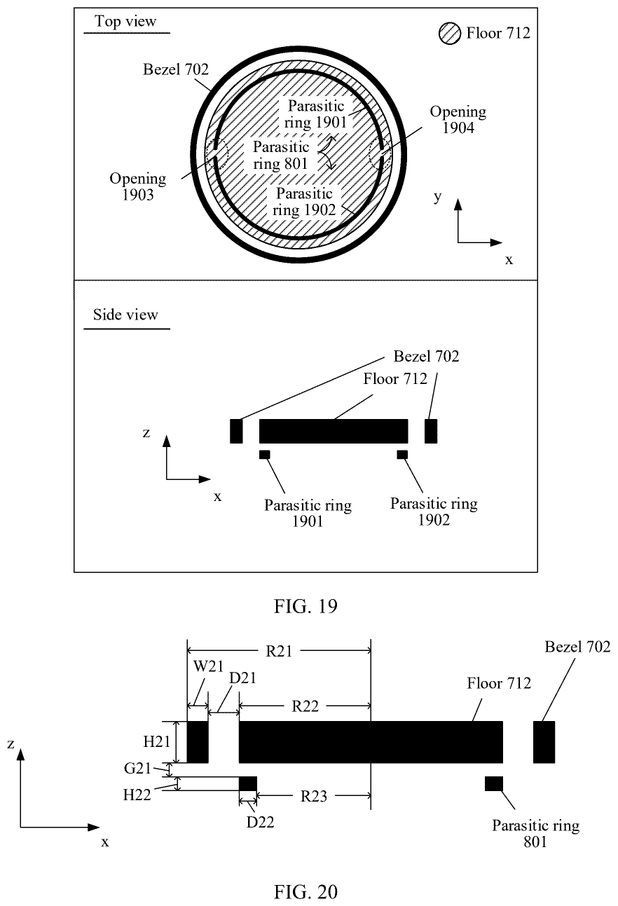

FIG. 19 is a schematic diagram of another antenna solution according to an embodiment of this application. In this example, the parasitic ring 801 is arranged at a position close to the floor 712. For example, a projection of the parasitic ring 801 may fall in a range of the floor 712. In this case, for an operation mechanism of the antenna solution in this example, reference may be made to the description in FIG. 12 or FIG. 13.

For example, as shown in a top view in FIG. 19, the ring structure of the parasitic ring 801 may include two openings, for example, an opening 1904 provided at a 3 o'clock position and an opening 1903 provided at a 9 o'clock position. The two openings may divide the ring structure of the parasitic ring 801 into two parts that are disconnected from each other, for example, an upper half of the parasitic ring 801 (that is, a parasitic ring 1901) and a lower half of the parasitic ring 801 (that is, a parasitic ring 1902). In some embodiments, the parasitic ring 1901 and the parasitic ring 1902 may be arranged symmetrically about a central point connecting line of the opening 1903 and the opening 1904.

Continue to refer to a side view in FIG. 19. A tangent plane of the side view may be a tangent plane of yoz passing through a geometrical center of an xoy plane of the watch. It can be learned from the side view that z-direction projections of the parasitic ring 1901 and the parasitic ring 1902 may fall in the floor 712. This may be regarded as the parasitic ring 801 being arranged close to the floor 712.

An operation situation of the antenna is described below with reference to the structure shown in FIG. 19. The side view shown in FIG. 19 is used as an example. FIG. 20 shows related dimensioning and descriptions of the antenna structure. Refer to FIG. 20. An outer radius of the bezel 702 may be R21. An x-direction width of the bezel 702 may be W21. A z-direction height of the bezel 702 may be H21. A radius of the floor 712 may be R22. A width of the gap between the floor 712 and the bezel 702 may be D21. For the parameters of the bezel 702 and the parameters of the floor 712, reference may be made to the example in FIG. 14. For example, R21 may be the same as R11. For another example, W21 may be the same as W11. The rest may be deduced by analogy.

In this example, a size of the parasitic ring 801 may be different from that in the example in FIG. 14. For example, an inner radius of the parasitic ring 801 may be R23. An x-direction width of the parasitic ring 801 may be D22. A z-direction height of the parasitic ring 801 may be H22. In this example, the parasitic ring 801 may be located on a different plane from the bezel 702 and the floor 712. For example, a z-direction distance between the parasitic ring 801 and the bezel 702 may be G21. In an example, in the following simulation, an example in which R21=23 mm, R22=19.5 mm, W21=1.5 mm, D21=2 mm, H21=5 mm, R23=17.5mm, D22=1.5 mm, G21=2 mm, H22=0.1 mm, and widths of the two openings of the parasitic ring 801 are both 0.5 mm is used. An operating status of the antenna structure shown in FIG. 19 is described with reference to current and S parameter simulation.

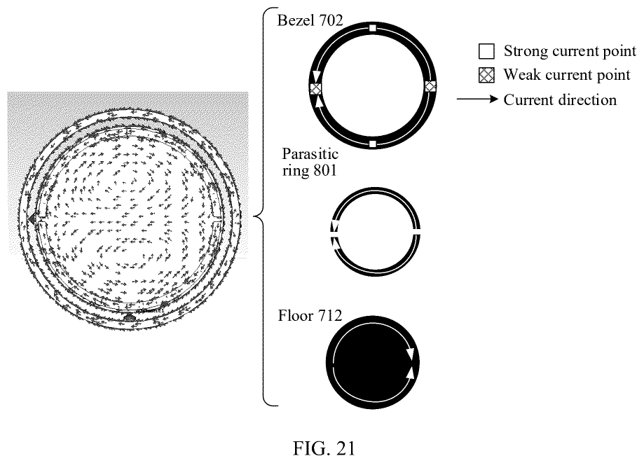

FIG. 21 shows a current distribution of each component during operation of the antenna of the structure shown in FIG. 19. For a clearer description, FIG. 21 also shows logical illustration of the current distribution on each component.

In this example, the current on the bezel 702 may flow from the weak current point nearby 3 o'clock to the weak current point nearby 9 o'clock. The strong current points are distributed in the 12 o'clock direction and the 6 o'clock direction. The direction of the current on the floor 712 is opposite to that of the current on the bezel 702, and a strong current point and a weak current point are distributed in a similar manner. For example, the current on the floor 712 may flow from the weak current point nearby 9 o'clock to the weak current point nearby 3 o'clock. Due to a skin effect of the current, a significant current on the floor 712 is distributed on an edge of the floor 712 in an arched manner. With reference to the illustration in FIG. 9, the current distribution coincides with the description in FIG. 9.

As shown in FIG. 21, the direction of the current on the parasitic ring 801 arranged close to the floor 712 may be opposite to that on the floor 712 and consistent with that on the bezel 702. For example, the current on the parasitic ring 801 may flow from the opening provided at 3 o'clock and the opening provided at 9 o'clock.

In this case, since the direction of the current on the parasitic ring 801 is opposite to that of the current on the floor 712, directions of magnetic fields generated by the currents respectively are opposite, and the magnetic fields may be counteracted in a space close to the forearm. Therefore, weakening adjustment is implemented on the magnetic field generated on the floor 712. Therefore, an intensity of the magnetic field radiated by the floor 712 to the forearm is low, and a loss of a total radiation amount of the antenna caused by the forearm is correspondingly reduced. This achieves the effect of improving the radiation performance of the antenna.

The radiation performance of the antenna during operation in the worn mode is described below through S parameter simulation. An example in which the one-wavelength mode is excited on the antenna to cover a frequency band nearby 1575 MHz is used.

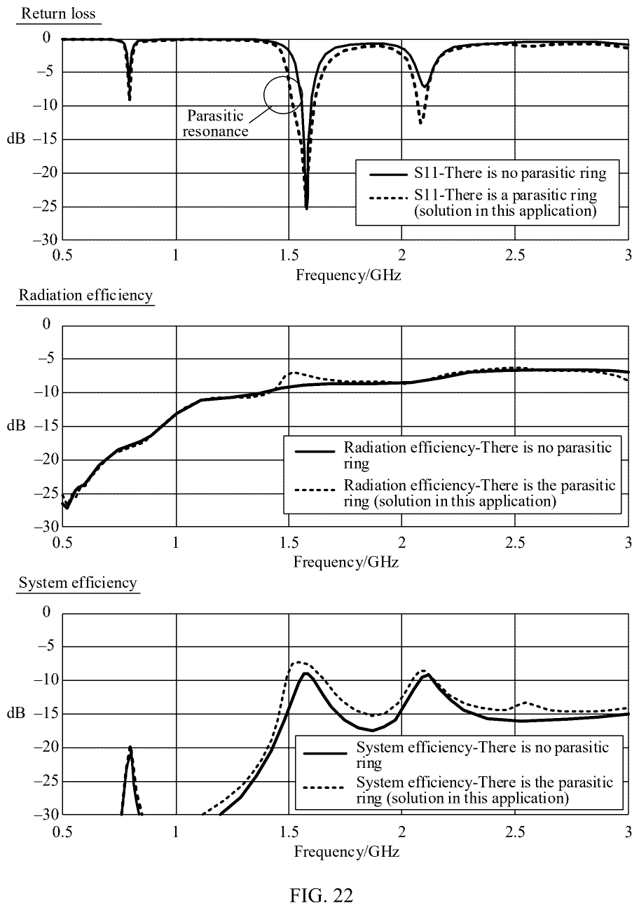

FIG. 22 is a schematic diagram of S parameter and efficiency simulation of the antenna having the composition shown in FIG. 19. As shown in FIG. 22, from the angle of a return loss (S11), after the design of the parasitic ring 801 is added, a resonance bandwidth of the frequency band nearby 1575 MHz is increased to some extent. In addition, the antenna can excite a low resonance at a frequency position lower than a main resonance nearby 1575 MHz. The low resonance may correspond to a mode excited by the parasitic ring 801 after coupling. From the angle of radiation efficiency, after the design of the parasitic ring 801 is added, the radiation efficiency in the frequency band nearby the main resonance is significantly improved, with a peak exceeding −8 dB, more than 2 dB higher than that in a solution in which the design of the parasitic ring 801 is not added. From the angle of system efficiency, peak efficiency of the main resonance is also more than 2 dB higher than that in the solution in which the design of the parasitic ring 801 is not added. In this example, the bezel 702 may play a dominant role in radiation. Therefore, when the direction of the current on the parasitic ring 801 is consistent with that of the current on the bezel 702, radiation generated by the parasitic ring 801 may promote radiation of the bezel 702 to some extent. In this way, the radiation performance of the antenna is improved while absorption of radiation of the floor 712 by the forearm is reduced. Improvement of the radiation performance of the antenna may be reflected in bandwidth and efficiency.

In the foregoing example, a parasitic resonance on a low-frequency side of the main resonance may be generated in a half-wavelength mode excited on the parasitic ring 801. In some other embodiments of this application, a half-wavelength mode excited on the parasitic ring 801 may alternatively be located on a high-frequency side of the main resonance through matching tuning or structural fine adjustment. A solution of adjusting a frequency band covered by the parasitic resonance is subsequently described in detail in FIG. 28 and FIG. 29. For example, the parasitic resonance may be adjusted through inductive loading and/or capacitive loading.

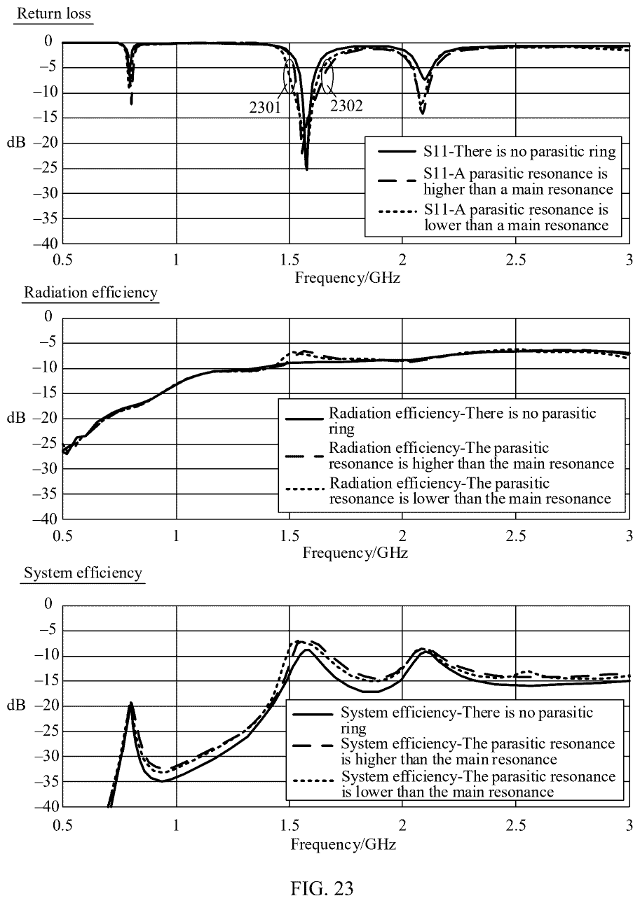

For example, FIG. 23 is a schematic diagram of S parameter and efficiency simulation when the parasitic resonance is located on the high-frequency side and the low-frequency side of the main resonance respectively. As shown in FIG. 23, from the angle of S11, when the parasitic resonance is located on the low-frequency side of the main resonance, the resonance may be identified as a parasitic resonance 2301. When the parasitic resonance is located on the high-frequency side of the main resonance, the resonance may be identified as a parasitic resonance 2302. It can be learned that no matter whether the parasitic resonance is located on the high-frequency side or the low-frequency side, a bandwidth of the main resonance is significantly extended. From the angle of the radiation efficiency, no matter whether the parasitic resonance is higher than the main resonance or the parasitic resonance is lower than the main resonance, corresponding radiation efficiency is improved by more than 2 dB nearby 1575 MHz. In addition, from the angle of the system efficiency, no matter whether the parasitic resonance is higher than the main resonance or the parasitic resonance is lower than the main resonance, corresponding system efficiency is improved by 2 dB nearby 1575 MHZ.

In different implementations, a dielectric material between the parasitic ring 801 and the bezel 702/floor 712 may be adjusted to implement dielectric loading with a material having an appropriate dielectric constant, to adjust a resonance position of the parasitic ring 801. For example, the parasitic ring 801 is arranged in the watch bottom through in-mold injection molding. Then, an appropriate non-metal material (for example, a plastic material) wrapping the parasitic ring 801 in the watch bottom may be selected to adjust the dielectric constant of the dielectric material, to implement a dielectric loading function. In some other implementations, the structure of the parasitic ring 801 may be adjusted to adjust the position of the parasitic resonance.

In the example in FIG. 19 to FIG. 23, implementation of the solution in which the parasitic ring 801 is arranged nearby the floor 712 in this application and operation effects are described. According to the antenna structure shown in FIG. 19, for example, when the parasitic resonance is tuned to the low-frequency side of the main resonance, the loss of the performance of the antenna caused by the forearm can be effectively reduced, and the radiation performance of the antenna in the worn mode can be improved.

In the description and the simulation examples in FIG. 14 to FIG. 23, an example in which the gap is provided between the watch bottom 703 and the forearm of the user is used for description. In some other scenarios, when the watch is worn, the watch bottom 703 may alternatively be close to or in contact with the forearm of the user. For the antenna solution with the parasitic ring 801 provided in this embodiment of this application, even though the watch bottom 703 is in contact with the forearm of the user, the antenna may still be endowed with high radiation performance.

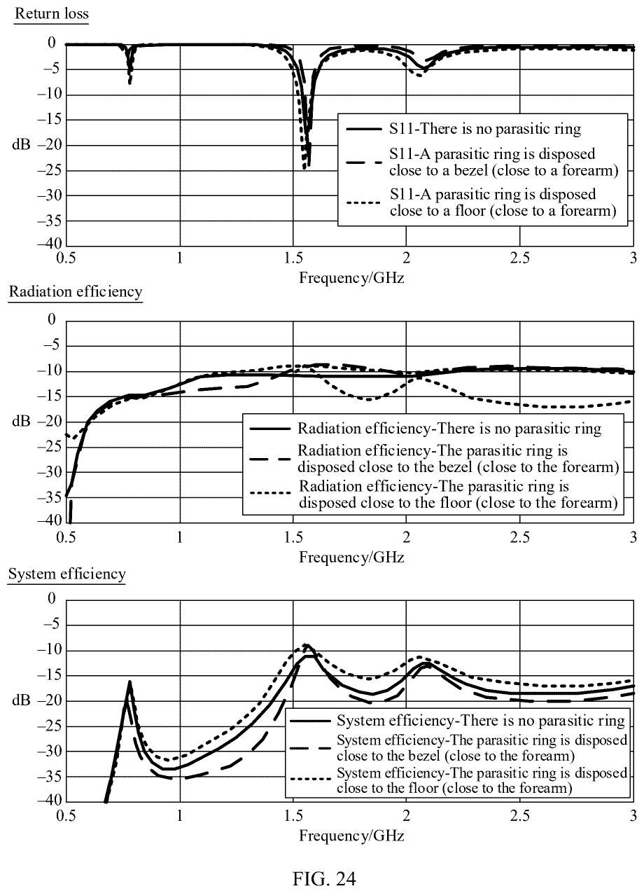

For example, FIG. 24 shows performance simulation of the solutions in which the parasitic ring 801 is arranged nearby the bezel 702 and nearby the floor 712 when the watch bottom 703 is close to the forearm. It can be learned from comparison between S parameter and efficiency simulation in the two solutions shown in FIG. 17 and FIG. 22 that in simulation in FIG. 24, even though the floor 712 is close to the forearm, higher radiation performance can be provided in the antenna solution in which the parasitic ring 801 is added. For example, in the solution without the parasitic ring 801, when the watch bottom 703 is close to the forearm, the peak efficiency is −11.1 dB. Correspondingly, after the parasitic ring 801 is added, the efficiency is about −9.1 dB in two cases in which the parasitic ring 801 is arranged close to the bezel 702 and close to the floor 712 respectively. It indicates that adding the parasitic ring 801 can bring the antenna a performance gain of more than 2 dB.

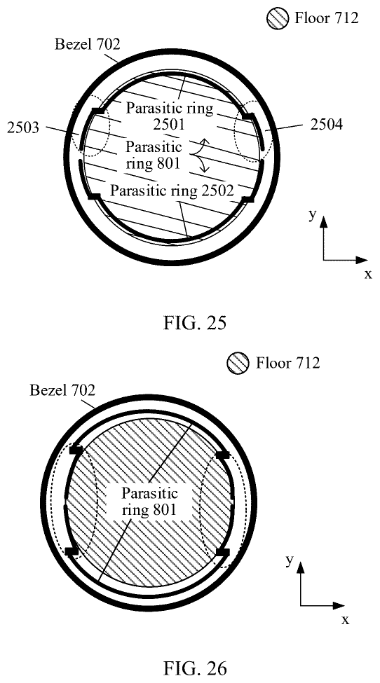

In the foregoing examples, the parasitic ring 801 may have a shape the same as or similar to those/that of the bezel 702 and/or the floor 712. In some other implementations, the parasitic ring 801 may have a different structure. For example, both the bezel 702 and the floor 712 are circular. FIG. 25 shows still another structural implementation of the parasitic ring 801. As a reference, FIG. 25 further shows illustration of the bezel 702. As shown in FIG. 25, the parasitic ring 801 may include two openings. The two openings are provided nearby 3 o'clock and 9 o'clock of the parasitic ring 801 respectively. The two openings may divide the parasitic ring 801 into two parts that are disconnected from each other. For example, the two parts that are disconnected from each other may include a parasitic ring 2501 and a parasitic ring 2502. In this example, the parasitic ring 2501 and the parasitic ring 2502 may be arranged axisymmetrically. The parasitic ring 2501 is used as an example. Different from the example in FIG. 19 or FIG. 14, in this example, the parasitic ring 2501 may be arranged with two ends close to the openings extending outward. For example, the parasitic ring 2501 may be provided with outward extending structures 2503 and 2504 at the ends close to the two openings. In this way, the end of the parasitic ring 2501 (that is, a large-electric-field region of the parasitic ring 2501) may be closer to the bezel 702. A middle position of the parasitic ring 2501 (that is, a large current region of the parasitic ring 2501) may be closer to the floor 712. For arrangement of the parasitic ring 2502, reference may be made to the parasitic ring 2501. Then, the large current region of the parasitic ring 801 is arranged close to the floor 712, so that the parasitic ring 801 can obtain a larger electric field coupling magnitude from the floor 712. Therefore, the position of the parasitic resonance of the parasitic ring 801 is tuned while the parasitic ring 801 is wired more flexibly. In some implementations, with arrangement of the parasitic ring 801 shown in FIG. 25, since the large current region of the parasitic ring 801 is arranged close to the floor 712, this structure can achieve effects similar to those of the solution in which the parasitic ring 801 is arranged close to the floor 712 in the structure shown in FIG. 19.

In some other embodiments of this application, refer to FIG. 25. As shown in FIG. 26, the end of the parasitic ring 801 close to the opening may be contracted inward, so that a large-electric-field region of the parasitic ring 801 is away from the bezel 702 and close to the floor 712. Therefore, the position of the parasitic resonance of the parasitic ring 801 can be tuned while the parasitic ring 801 is wired more flexibly. In some implementations, with arrangement of the parasitic ring 801 shown in FIG. 26, since the large current region of the parasitic ring 801 is arranged close to the bezel 702, this structure can achieve effects similar to those of the solution in which the parasitic ring 801 is arranged close to the bezel 702 in the structure shown in FIG. 14.

It should be noted that structural variations of the parasitic ring 801 in FIG. 25 and FIG. 26 are merely examples. In some other implementations, the structure of the parasitic ring 801 may be a structure other than those/that of the bezel 702 and/or the floor 712. A specific operation mechanism and effects of the parasitic ring 801 are similar to those in the foregoing examples. Details are not described herein again.

In addition, an example in which the parasitic ring 801 includes two upper and lower symmetric radiators that are disconnected from each other is used for description in the foregoing examples. It should be understood that even though the parasitic ring 801 is only partly arranged, similar effects can be achieved.

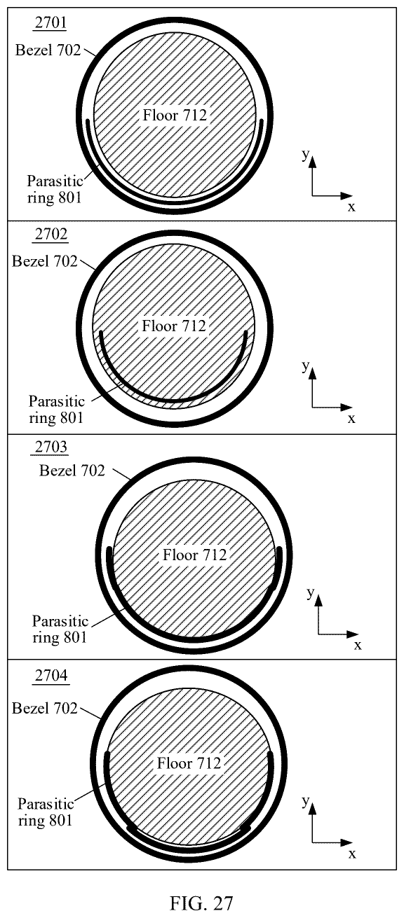

For example, FIG. 27 shows several possible examples of arrangement of the parasitic ring 801 according to an embodiment of this application. As shown in 2701, the parasitic ring 801 may include one half ring structure arranged close to the bezel 702. For example, the parasitic ring 801 may be arranged at a lower half of the gap between the floor 712 and the bezel 702. In this way, the parasitic ring 801 may be configured to perform weakening tuning on a magnetic field radiated by the lower half of the bezel 702, thereby reducing a loss of radiation of the lower half of the bezel 702 caused by the human body and improving the performance of the antenna. With reference to the example in FIG. 14, this solution is limited in magnetic field weakening tuning capability, but a space required for arrangement of the parasitic ring 801 can be significantly reduced, so that application flexibility of the solution is improved. During practical use, a corresponding implementation solution of the parasitic ring 801 may be selected based on a specific situation. In this example, an example in which the parasitic ring 801 is arranged at the lower half of the gap between the floor 712 and the bezel 702 is used. In some other implementations, the parasitic ring 801 may be arranged at an upper half of the gap between the floor 712 and the bezel 702, which can achieve similar effects. Details are not described herein again.

As shown in 2702, the parasitic ring 801 may include one half ring structure arranged close to the floor 712. For example, the parasitic ring 801 may be arranged at a lower half of a projection range of the floor 712. In this way, the parasitic ring 801 may be configured to perform weakening tuning on a magnetic field radiated by the lower half of the floor 712, thereby reducing a loss of radiation of the lower half of the floor 712 caused by the human body and improving the performance of the antenna. With reference to the example in FIG. 19, this solution is limited in magnetic field weakening tuning capability, but a space required for arrangement of the parasitic ring 801 can be significantly reduced, so that application flexibility of the solution is improved. During practical use, a corresponding implementation solution of the parasitic ring 801 may be selected based on a specific situation. In this example, an example in which the parasitic ring 801 is arranged at the lower half of the projection range of the floor 712 is used. In some other implementations, the parasitic ring 801 may be arranged at an upper half of the projection range of the floor 712, which can achieve similar effects. Details are not described herein again.

In examples shown in 2703 and 2704 in FIG. 27, a half ring structure of the parasitic ring 801 may be adjusted to a design that the half ring structure is partly close to or away from the bezel 702. In this way, effects similar to those in the solution shown in FIG. 25 or FIG. 26 are achieved.

Through the description in FIG. 14 to FIG. 27, a person skilled in the art should be able to have a comprehensive understanding of the operation mechanism of the structure of the parasitic ring 801 provided in this embodiment of this application and effects of the structure in improving the performance of the antenna in the watch. In the description in FIG. 14 to FIG. 27, an example in which the bezel 702 operates in the one-wavelength mode is used. With reference to the description about the parasitic ring 801 in FIG. 8, when the bezel 702 operates in the one-wavelength mode, two strong current points and two weak current points may be distributed on a surface of the bezel 702, and the parasitic ring 801 may correspondingly include two openings. The two openings may be distributed in correspondence to the two weak current points on the bezel 702. When the bezel 702 operates in another mode, the structure of the parasitic ring 801 may be correspondingly adjusted.

For example, an example in which the bezel 702 operates in the ½-wavelength mode is used. In this case, a diameter L of the bezel 702 may correspond to ½ of an operating wavelength. Refer to FIG. 28. An example in which feeding is performed at 3 o'clock and grounding is performed at 6 o'clock is used. In this case, one strong current point and one weak current point may be distributed on the bezel 702. The strong current point may be nearby 6 o'clock. The weak current point may be nearby 12 o'clock. Therefore, the opening of the parasitic ring 801 may be provided nearby 12 o'clock, corresponding to a position of the weak current point on the bezel 702. In different implementations, the parasitic ring 801 may be arranged close to the bezel 702, or may be arranged close to the floor 712.

Tuning the parasitic resonance excited on the parasitic ring 801 may be implemented in a dielectric loading form, or may be implemented by adjusting the structure of the parasitic ring 801. For example, FIG. 29 shows illustration of two structural variations of the parasitic ring 801. In 2901, inductive loading may be arranged at a position of the parasitic ring 801 close to the strong current point on the bezel 702 (that is, nearby 6 o'clock). For example, distributed inductive loading is used as an example. A radiator width of the parasitic ring 801 nearby 6 o'clock may be different from that at another position. For example, the parasitic ring 801 is arranged to be a thin radiator, that is, the radiator is prolonged, so that a frequency band covered by the resonance excited by the structure of the parasitic ring 801 is lower. For another example, the parasitic ring 801 is arranged to be thick, that is, the radiator is shortened, so that a frequency band covered by the resonance excited by the structure of the parasitic ring 801 is higher. In this way, inductive loading performed on the strong current point on the bezel 702 is implemented. In an example in 2902, the opening of the parasitic ring 801 may be adjusted to distributed capacitance, to implement capacitive loading performed on the weak current point on the bezel 702. For example, a capacitive loading structure is arranged, that is, the radiator is prolonged, so that the parasitic resonance may be shifted to a low frequency. For another example, when a capacitive loading structure is arranged, capacitance for capacitive loading is adjusted, for example, a gap width is increased, that is, the radiator is shortened, so that the parasitic resonance may be shifted to a high frequency. During specific implementation, a loading magnitude of inductive loading/capacitive loading may be flexibly adjusted based on a specific situation. This is not limited in this embodiment of this application. Certainly, in some other implementations, distributed inductive/capacitive loading in the foregoing example may be replaced with inductive/capacitive loading implemented through an integrated device. In this way, a current opposite to that on the bezel 702/floor 712 can be generated on the parasitic ring 801 through inductive loading/capacitive loading. Therefore, weakening adjustment on the magnetic field on the side close to the forearm is implemented, and the performance of the antenna is improved. In addition, the metal ring structure may be arranged to be a closed ring structure. A cross sectional size of the closed ring structure is set to adjust the parasitic resonance to be shifted to the low frequency. For example, if cross sections of some regions of a metal ring structure with a uniform cross sectional size are designed to be smaller than those of other regions, the frequency band covered by the resonance excited on the metal ring structure is lower. On the contrary, if cross sections of some regions of a metal ring structure with a uniform cross sectional size are designed to be larger than those of other regions, the frequency band covered by the resonance excited on the metal ring structure is higher.

It should be understood that when the perimeter L of the bezel 702 corresponds to one wavelength, the bezel 702 operates in the one-wavelength mode, and capacitive loading/inductive loading similar to that in FIG. 29 may be arranged on the parasitic ring 801 to implement weakening adjustment on the magnetic field.

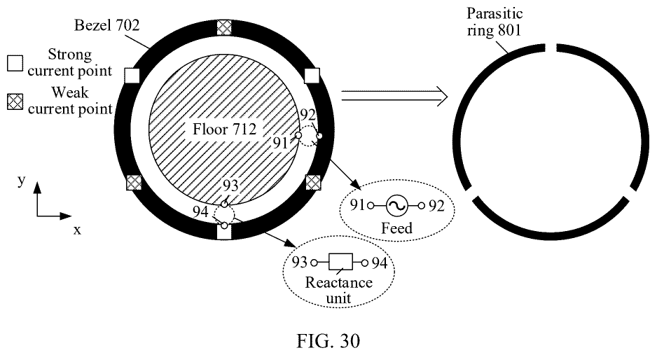

An example in which the bezel 702 operates in a 3/2-wavelength mode is used as an example below. In this case, a diameter L of the bezel 702 may correspond to 3/2 of an operating wavelength. Refer to FIG. 30. An example in which feeding is performed at 3 o'clock and grounding is performed at 6 o'clock is used. In this case, three strong current points and three weak current points may be distributed on the bezel 702. The strong current points may be nearby a 6 o'clock position, a position between 10 o'clock and 11 o'clock, and a position between 1 o'clock and 2 o'clock. The weak current points may be nearby a 12 o'clock position, a position between 4 o'clock and 5 o'clock, and a position between 7 o'clock and 8 o'clock. Therefore, three openings of the parasitic ring 801 may be provided at three positions that respectively correspond to the weak current points on the bezel 702 and that are respectively at 12 o'clock, between 4 o'clock and 5 o'clock, and between 7 o'clock and 8 o'clock. In different implementations, the parasitic ring 801 may be arranged close to the bezel 702, or may be arranged close to the floor 712.

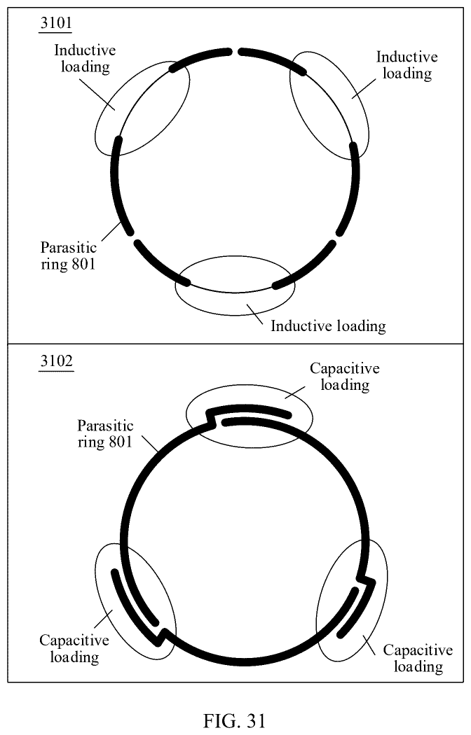

Tuning the parasitic resonance excited on the parasitic ring 801 may be implemented in a dielectric loading form, or may be implemented by adjusting the structure of the parasitic ring 801. For example, FIG. 31 shows illustration of two structural variations of the parasitic ring 801. In 3101, inductive loading may be arranged at positions of the parasitic ring 801 close to the strong current points on the bezel 702 (for example, nearby at 6 o'clock position, the position between 10 o'clock and 11 o'clock, and the position between 1 o'clock and 2 o'clock). For example, distributed inductive loading is used as an example. Wiring of the parasitic ring 801 at inductive loading may be different from that at another position. For example, the parasitic ring 801 is arranged to be a thin radiator, that is, the radiator is prolonged. For example, the parasitic ring 801 is arranged to be thick, that is, the radiator is shortened. In this way, inductive loading performed on the strong current point on the bezel 702 is implemented. In an example in 3102, the opening of the parasitic ring 801 may be adjusted to distributed capacitance, to implement capacitive loading performed on the weak current point on the bezel 702. Specific implementation is similar to the description in FIG. 29. In this way, a current opposite to that on the bezel 702/floor 712 can be generated on the parasitic ring 801 through inductive/capacitive loading. Therefore, weakening adjustment on the magnetic field on the side close to the forearm is implemented, and the performance of the antenna is improved.

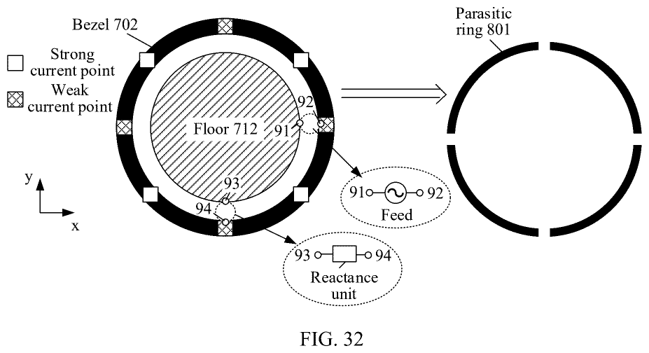

An example in which the bezel 702 operates in a 4/2-wavelength mode (for example, two wavelengths) is used as an example below. In this case, a diameter L of the bezel 702 may correspond to twice of an operating wavelength. Refer to FIG. 32. An example in which feeding is performed at 3 o'clock and grounding is performed at 6 o'clock is used. In this case, four strong current points and four weak current points may be distributed on the bezel 702. The strong current points may be nearby corresponding positions between 1 o'clock and 2 o'clock, between 4 o'clock and 5 o'clock, between 7 o'clock and 8 o'clock, and between 10 o'clock and 11 o'clock. The weak current points may be nearby corresponding positions at 12 o'clock, 3 o'clock, 6 o'clock, and 9 o'clock. Therefore, four openings of the parasitic ring 801 may be provided at the four positions that respectively correspond to the weak current points on the bezel 702 and that are at 12 o'clock, 3 o'clock, 6 o'clock, and 9 o'clock. In different implementations, the parasitic ring 801 may be arranged close to the bezel 702, or may be arranged close to the floor 712.

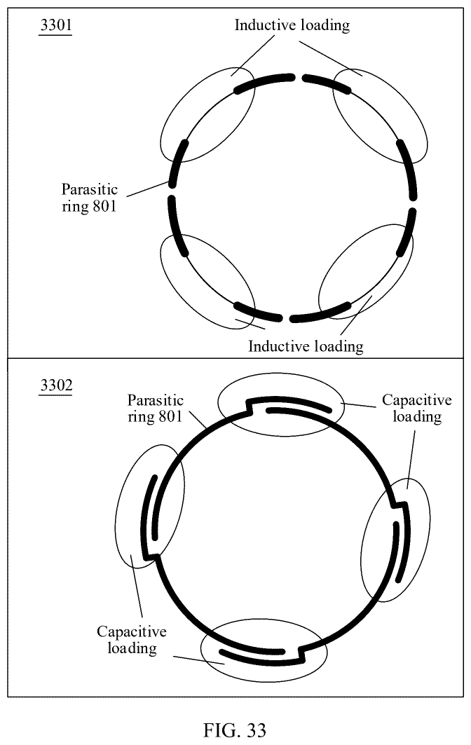

Tuning the parasitic resonance excited on the parasitic ring 801 may be implemented in a dielectric loading form, or may be implemented by adjusting the structure of the parasitic ring 801. For example, FIG. 33 shows illustration of two structural changes of the parasitic ring 801. 3301 shows illustration of inductive loading. 3302 shows illustration of capacitive loading. For specific implementation, reference may be made to the description about loading in the ½-wavelength mode and the 3/2-wavelength mode. Similarly, during specific implementation of this example, a loading magnitude of inductive loading/capacitive loading may be flexibly adjusted based on a specific situation. For example, the inductive loading and capacitive loading structures shown in FIG. 33 can achieve the effect of tuning the parasitic resonance to the low frequency. Correspondingly, the inductive loading structure in 3301 is adjusted to a thick wiring structure, or a coupling area of capacitive loading in 3302 can be reduced to correspondingly adjust the parasitic resonance to the high frequency. This is not limited in this embodiment of this application. In this way, a current opposite to that on the bezel 702/floor 712 can be generated on the parasitic ring 801 through inductive loading/capacitive loading. Therefore, weakening adjustment on the magnetic field on the side close to the forearm is implemented, and the performance of the antenna is improved. In addition, inductive loading and capacitive loading shown in this example may be replaced with the integrated device to implement corresponding functions.

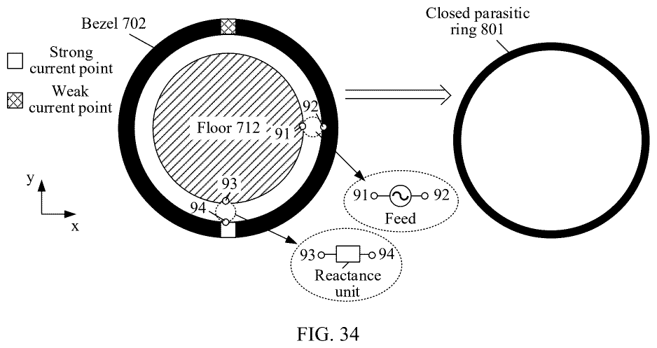

In the foregoing descriptions, the design of the parasitic ring 801 may correspond to a mode corresponding to the main resonance excited at the operating wavelength. For example, the parasitic ring 801 may be provided with N openings separately corresponding to the bezel 702 operating in the N/2-wavelength mode. The opening may be provided at a position corresponding to the weak current point on the bezel 702. It should be understood that in this embodiment of this application, to implement weakening adjustment on the magnetic field, a form of the parasitic ring 801 is used. The weak current point on the bezel 702 corresponds to a weak magnetic field point. Therefore, weakening adjustment on the magnetic field is performed mainly for a strong magnetic field point corresponding to the strong current point. That is, whether to provide an opening at the weak magnetic field point corresponding to the weak current point does not significantly affect magnetic field weakening adjustment effects. Therefore, in some other embodiments of this application, the parasitic ring 801 may be provided with no opening, that is, the parasitic ring 801 may be a closed ring structure. With reference to FIG. 34, in this example, an example in which the bezel 702 operates in the ½-wavelength mode is used. The design of the parasitic ring 801 may also be a closed ring structure. It should be understood that the structure shown in FIG. 34 can achieve effects similar to those in the foregoing example.

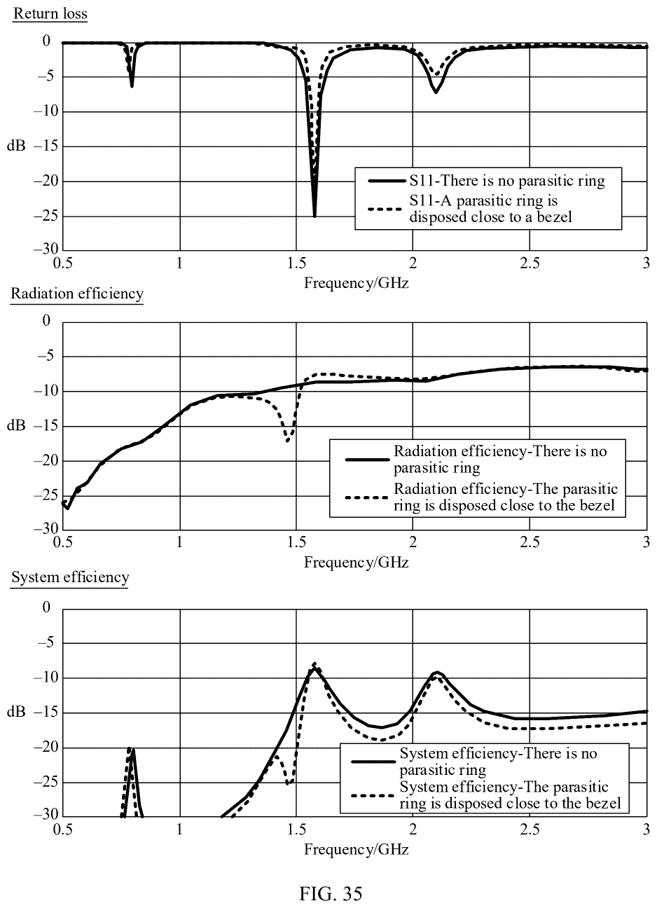

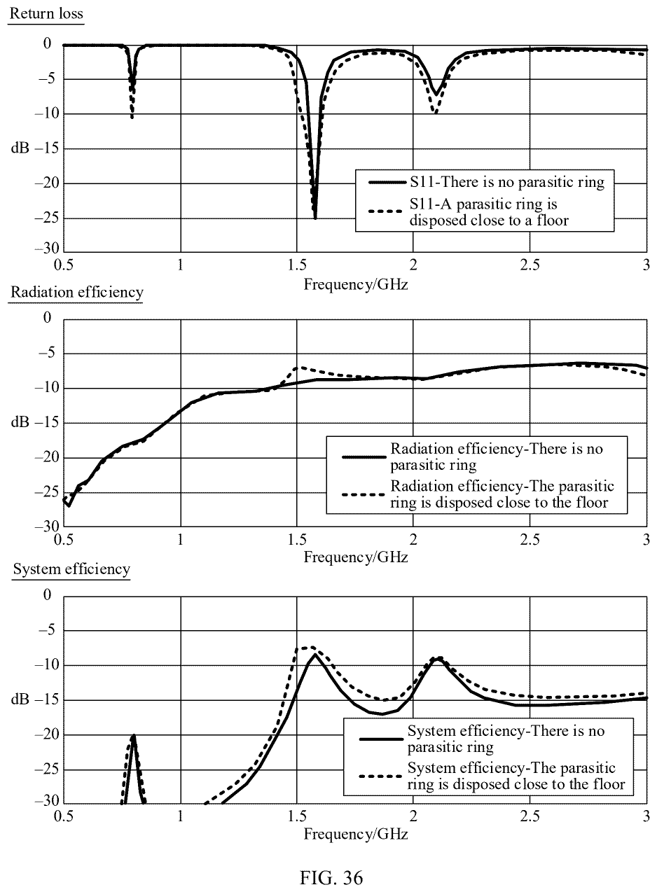

For example, FIG. 35 shows an example of simulation results obtained when the parasitic ring 801 of the closed ring structure is arranged at a position close to the bezel 702. An example in which the bezel 702 operates in the ½-wavelength mode is used. Refer to the simulation results in the solution of the parasitic ring 801 provided with two openings in the one-wavelength mode shown in FIG. 17. Effects achieved by the closed ring structure are similar to those achieved by the structure shown in FIG. 14. For example, as shown in FIG. 35, from the angle of S11, after the parasitic ring 801 is arranged, a resonance bandwidth is slightly reduced, the radiation efficiency is significantly improved, and the system efficiency is improved to some extent. FIG. 36 shows an example of simulation results obtained when the parasitic ring 801 of the closed ring structure is arranged at a position close to the floor 712. An example in which the bezel 702 operates in the ½-wavelength mode is used. Refer to the simulation results of the solution of the parasitic ring 801 provided with two openings in the one-wavelength mode shown in FIG. 22. Effects achieved by the closed ring structure are similar to those achieved by the structure shown in FIG. 19.

It should be noted that in various implementations provided in the embodiments of this application, the non-closed parasitic ring structure with the opening can effectively implement optimal adjustment on the radiation performance in a single mode. For a closed parasitic ring structure, radiation may be performed on the parasitic ring in a plurality of different modes. Therefore, during specific implementation, a specific coverage interval of the closed parasitic ring structure may be flexibly selected based on a specific mode and a current distribution of the main resonance required to be adjusted, to effectively implement optimal adjustment of the radiation performance of the main resonance.

Although this application has been described in combination with specific features and embodiments thereof, it is apparent that various modifications and combinations may be made thereto without departing from the spirit and scope of this application. Correspondingly, the specification and the accompanying drawings are merely example descriptions of this application defined in the appended claims, and are considered as any of or all modifications, variations, combinations or equivalents that cover the scope of this application. It is clear that a person skilled in the art can make various modifications and variations to this application without departing from the spirit and scope of this application. This application is intended to cover these modifications and variations of this application provided that they fall within the scope of the claims of this application and their equivalent technologies.

1. A terminal antenna, wherein the terminal antenna is used in a wearable device;
the terminal antenna comprises a first radiator, a reference ground, and a metal ring structure;
the first radiator has a hollow structure, and a projection of the reference ground on a plane on which the first radiator is located is located inside the hollow structure of the first radiator;
a projection of the metal ring structure on the first radiator is not beyond the structure of the first radiator, wherein the metal ring structure is a parasitic ring structure; and
when the wearable device is in a worn state, a distance between the metal ring structure and a user is less than that between the first radiator and the user.

2. (canceled)

3. The terminal antenna according to claim 1, wherein a perimeter of the first radiator corresponds to an N/2 wavelength of an operating frequency band of the terminal antenna; and
the parasitic ring structure is provided with at most N openings, and any one of the at most N openings is provided close to a weak current point generated when the first radiator operates; or the parasitic ring structure is a closed ring structure.

4. The terminal antenna according to claim 1, wherein
the metal ring structure is arranged close to the first radiator; and
when the terminal antenna operates, a current direction on the metal ring structure is opposite to that on the first radiator.

5. The terminal antenna according to claim 4, wherein that the metal ring structure is arranged close to the first radiator comprises:
the metal ring structure is arranged in a first region, wherein the first region comprises a projection region of a gap between the first radiator and the reference ground on a plane on which the metal ring structure is located, and/or a projection region of the first radiator on a plane on which the metal ring structure is located; or
when the metal ring structure is provided with an opening, a middle part of at least one continuous radiator in the metal ring structure is arranged in the first region.

6. The terminal antenna according to claim 4, wherein when the terminal antenna operates, a first parasitic resonance corresponding to a half-wavelength mode is excited on the metal ring structure, a main resonance corresponding to an N/2-wavelength mode is excited on the first radiator, and a frequency band covered by the first parasitic resonance at least partly coincides with that covered by the main resonance.

7. The terminal antenna according to claim 1, wherein
the metal ring structure is arranged close to the reference ground; and
when the terminal antenna operates, a current direction on the metal ring structure is opposite to that on the reference ground.

8. The terminal antenna according to claim 7, wherein that the metal ring structure is arranged close to the reference ground comprises:
the metal ring structure is arranged in a second region, wherein the second region comprises a projection region of the reference ground on a plane on which the metal ring structure is located; or
when the metal ring structure is provided with an opening, a middle part of at least one continuous radiator in the metal ring structure is arranged in the second region.

9. The terminal antenna according to claim 7, wherein when the terminal antenna operates, a second parasitic resonance corresponding to a half-wavelength mode is excited on the metal ring structure, a main resonance corresponding to an N/2-wavelength mode is excited on the first radiator, and a frequency band covered by the second parasitic resonance at least partly coincides with that covered by the main resonance.

10. The terminal antenna according to claim 1, wherein
the metal ring structure is provided with at least one opening, wherein if cross sections of some radiators on a parasitic ring opposite to the opening are smaller than those of other radiators, a frequency band covered by a resonance excited on the metal ring structure is lower, or if cross sections of some radiators on a parasitic ring opposite to the opening are larger than those of other radiators, a frequency band covered by a resonance excited on the metal ring structure is higher; or
the metal ring structure is a closed ring structure, wherein if cross sections of some regions of the metal ring structure are smaller than those of other regions, a frequency band covered by a resonance excited on the metal ring structure is lower.

11. The terminal antenna according to claim 1, wherein the metal ring structure is provided with the at least one opening;
the metal ring structure comprises a first part and a second part at a position of the opening, and the first part at least partly coincides with the second part to form equivalent capacitance; and
if the equivalent capacitance is higher, the frequency band covered by the resonance excited on the metal ring structure is lower, or if the equivalent capacitance is lower, the frequency band covered by the resonance excited on the metal ring structure is higher.

12. The terminal antenna according to claim 11, wherein projection regions of the first part and the second part on the first radiator coincide.

13. A wearable device, wherein the terminal antenna according to claim 1 is arranged in the wearable device.

14. The wearable device according to claim 13, wherein the wearable device is a smartwatch, and the first radiator is a metal bezel of the smartwatch.

15. The wearable device according to claim 13, wherein the metal ring structure is arranged on a watch bottom.

16. The terminal antenna according to claim 3, wherein
the metal ring structure is arranged close to the first radiator; and
when the terminal antenna operates, a current direction on the metal ring structure is opposite to that on the first radiator.

17. The terminal antenna according to claim 16, wherein that the metal ring structure is arranged close to the first radiator comprises:
the metal ring structure is arranged in a first region, wherein the first region comprises a projection region of a gap between the first radiator and the reference ground on a plane on which the metal ring structure is located, and/or a projection region of the first radiator on a plane on which the metal ring structure is located; or
when the metal ring structure is provided with an opening, a middle part of at least one continuous radiator in the metal ring structure is arranged in the first region.

18. The terminal antenna according to claim 17, wherein when the terminal antenna operates, a first parasitic resonance corresponding to a half-wavelength mode is excited on the metal ring structure, a main resonance corresponding to an N/2-wavelength mode is excited on the first radiator, and a frequency band covered by the first parasitic resonance at least partly coincides with that covered by the main resonance.

19. The terminal antenna according to claim 3, wherein
the metal ring structure is arranged close to the reference ground; and
when the terminal antenna operates, a current direction on the metal ring structure is opposite to that on the reference ground.

20. The terminal antenna according to claim 19, wherein that the metal ring structure is arranged close to the reference ground comprises:
the metal ring structure is arranged in a second region, wherein the second region comprises a projection region of the reference ground on a plane on which the metal ring structure is located; or
when the metal ring structure is provided with an opening, a middle part of at least one continuous radiator in the metal ring structure is arranged in the second region.

21. The terminal antenna according to claim 20, wherein when the terminal antenna operates, a second parasitic resonance corresponding to a half-wavelength mode is excited on the metal ring structure, a main resonance corresponding to an N/2-wavelength mode is excited on the first radiator, and a frequency band covered by the second parasitic resonance at least partly coincides with that covered by the main resonance.
